(19) United States
(12) Patent Application Publication
(10) Pub. No.: US 2025/0321398 A1
(43) Pub. Date: Oct. 16, 2025

(54) OPTICAL SYSTEM AND CAMERA MODULE FOR VEHICLE

(71) Applicant: LG INNOTEK CO., LTD., Seoul (KR)

(72) Inventor: Chang Gyun SON, Seoul (KR)

(21) Appl. No.: 18/259,467

(22) PCT Filed: Dec. 28, 2021
(86) PCT No.: PCT/KR2021/020081

§ 371 Date: Jun. 27, 2023

(30) Foreign Application Priority Data
Dec. 28, 2020 (KR) 10-2020-0185154

(51) Int. Cl. G02B 9/58; G02B 1/04; G02B 3/04; G02B 7/02; H04N 23/51; H04N 23/55

(52) U.S. Cl. CPC G02B 9/58; G02B 1/041; G02B 3/04; G02B 7/021; H04N 23/51; H04N 23/55

(57) ABSTRACT

An optical system for a vehicle disclosed in an embodiment of the invention includes a first lens, a second lens, a third lens, and a fourth lens disposed along an optical axis from an object side toward a sensor side, the first lens includes an object-side first surface and a sensor-side second surface on the optical axis, the second lens includes an object-side third surface and a sensor-side fourth surface, the third lens includes an object-side fifth surface and a sensor-side sixth surface, the fourth lens includes an object-side seventh surface and a sensor-side eighth surface, the first lens has a negative refractive power, the third lens has a positive refractive power, the fourth lens has a negative refractive power, the first lens and the fourth lens include a plastic material, and the third lens comprises a glass material.

### CROSS-REFERENCE TO RELATED APPLICATIONS

This application is the U.S. national stage application of International Patent Application No. PCT/KR2021/020081, filed Dec. 28, 2021, which claims the benefit under 35 U.S.C. § 119 of Korean Application No. 10-2020-0185154, filed Dec. 28, 2020, the disclosures of each of which are incorporated herein by reference in their entirety.

### TECHNICAL FIELD

An embodiment of the invention relates to an optical system and a camera module for a vehicle.

### BACKGROUND ART

ADAS (Advanced Driving Assistance System) is an advanced driver assistance system for assisting the driver in driving, and consists of sensing the situation ahead, determining the situation based on the sensed result, and controlling the vehicle behavior based on the situation judgment. For example, an ADAS sensor device detects a vehicle ahead and recognizes a lane. Then, when the target lane, target speed, and forward target are determined, the vehicle's Electrical Stability Control (ESC), EMS (Engine Management System), and MDPS (Motor Driven Power Steering) are controlled. Typically, ADAS may be implemented as an automatic parking system, a low-speed city driving assistance system, a blind spot warning system, and the like. Sensor devices for sensing the situation ahead in ADAS include a GPS sensor, laser scanner, front radar, lidar, etc. The most representative is a front camera for capturing the front of the vehicle.

In recent years, research on a sensing system for sensing the surroundings of a vehicle for driver's safety and convenience has been accelerated. The vehicle detection system is used for various purposes, such as detecting objects around the vehicle to inhibit collisions with objects not recognized by the driver, and automatically parking by detecting empty spaces, and provides the most essential data for automatic vehicle control. As such a detection system, a method using a radar signal and a method using a camera are commonly used. A camera module for a vehicle is used by being built into a front and rear surveillance camera and a dashboard camera in an automobile, and takes a picture or video of a subject. Since the vehicle camera module is exposed to the outside, photographing quality may deteriorate due to humidity and temperature. In particular, the camera module has a problem in that optical characteristics are changed depending on the ambient temperature and the material of the lens.

### DISCLOSURE

### Technical Problem

An embodiment of the invention may provide an optical system for vehicle in which a plastic lens and a glass lens are mixed and a camera module having the same. An embodiment of the invention may provide an optical system for a vehicle in which a lens having an aspherical surface and a lens having a spherical surface are mixed on an object side and a sensor side, and a camera module having the same. An embodiment of the invention may provide an optical system having at least four lenses in which plastic lenses and glass lenses are aligned in a direction of an optical axis, and a camera module including the same.

### Technical Solution

An optical system for a vehicle according to an embodiment of the invention comprises a first lens, a second lens, a third lens, and a fourth lens sequentially stacked along an optical axis from an object side to a sensor, wherein the first lens includes an object-side first surface and a sensor-side second surface on the optical axis, the second lens includes an object-side third surface and a sensor-side fourth surface, the third lens includes an object-side fifth surface and a sensor-side sixth surface, the fourth lens includes an object-side seventh surface and a sensor-side eighth surface, the first lens has negative refractive power, the third lens has positive refractive power, the fourth lens has negative refractive power, the first lens and the fourth lens may include a plastic material, and the third lens may include a glass material.

An optical system for a vehicle according to an embodiment of the invention comprises a first lens, a second lens, a third lens, and a fourth lens sequentially stacked along an optical axis from an object side to a sensor, wherein the first lens includes an object-side first surface and a sensor-side second surface on the optical axis, the second lens includes an object-side third surface and a sensor-side fourth surface, the third lens includes an object-side fifth surface and a sensor-side sixth surface, the fourth lens includes an object-side seventh surface and a sensor-side eighth surface, the first lens has negative refractive power, the third lens has positive refractive power, the fourth lens has negative refractive power, and the first to fourth lenses may have a ratio of a plastic material to a glass material of 3:1.

According to an embodiment of the invention, the second lens is made of a plastic material, and the second lens may have a positive refractive power. A ratio of a spherical surface to an aspherical surface on an optical axis among the first to eighth surfaces of the first to fourth lenses may be 1:3. In the optical system, TTL is 11 mm or less, and F number may be 2 to 2.3.

According to an embodiment of the invention, the first lens has a concave first surface and a concave second surface on the optical axis, the second lens has a convex third surface and a convex fourth surface on the optical axis, the third lens has a convex fifth surface and a convex sixth surface on the optical axis, the fourth lens has a convex seventh surface and an concave eighth surface on the optical axis, and a distance between the third and fourth lenses in the optical system is greater than distances between the other two lenses. An Abbe number Vd of the first lens may be greater than the Abbe numbers of the second to fourth lenses. The Abbe number of the first lens may be greater than or equal to 50, and the Abbe numbers of the second, third, and fourth lenses may be less than 30.

According to an embodiment of the invention, the first lens has a concave first surface and a concave second surface on the optical axis, the second lens has a convex third surface and a convex fourth surface on the optical axis, the third lens has a convex fifth surface and a convex sixth surface on the optical axis, the fourth lens has a convex seventh surface and a concave eighth surface on the optical axis, a distance between the third and fourth lenses in the optical system is greater than distances between the other two lenses, and a center thickness of the second lens may be greater than center thicknesses of the first and third lenses.

According to an embodiment of the invention, the first lens has a concave first surface and a concave second surface on the optical axis, the second lens has a convex third surface and a convex fourth surface on the optical axis, the third lens has a convex fifth surface and a convex sixth surface on the optical axis, the fourth lens has a convex seventh surface and a convex eighth surface on the optical axis, and a distance between the third and fourth lenses in the optical system is greater than distances between the other two lenses, and a center thickness of the second lens may be greater than center thicknesses of the first and third lenses.

According to an embodiment of the invention, the first lens has a convex first surface and a concave second surface on the optical axis, the second lens has a concave third surface and a convex fourth surface on the optical axis, the third lens has a convex fifth surface and a concave sixth surface on the optical axis, the fourth lens has a convex seventh surface and a concave eighth surface on the optical axis, a center thickness of the second lens is the thickest in the optical system, a distance between the third and fourth lenses may be the largest among distances between lenses in the optical system. The first lens has a concave first surface and a concave second surface on the optical axis, the second lens has a convex third surface and a concave fourth surface on the optical axis, the third lens has a convex fifth surface and a convex sixth surface on the optical axis, the fourth lens has a convex seventh surface and a concave eighth surface on the optical axis, a center thickness of the first lens is the thickest in the optical system, and a distance between the second and third lenses and a distance between the third and fourth lenses may be 1 mm or more. An aperture stop disposed around a circumference between the second lens and the third lens may be included.

A camera module according to an embodiment of the invention comprises an image sensor; an optical filter on the image sensor; a cover glass disposed between the optical filter and the image sensor; an optical system in which a first lens, a second lens, a third lens, and a fourth lens are sequentially stacked along an optical axis from an object side to a sensor, and an aperture stop disposed on a circumference between the second lens and the third lens, wherein an effective diameter of the first lens is larger than an effective diameter of each of the second and third lenses, the third lens includes a glass material, object-side surfaces and sensor-side surfaces of the first, second and fourth lenses may be aspherical surfaces, the first lens has negative refractive power, the second and third lenses have positive refractive power, and the fourth lens may have negative refractive power.

According to an embodiment of the invention, the lens barrel having the first to fourth lenses may be made of a metal material.

### Advantageous Effects

In the optical system according to an embodiment of the invention, deformation of the lens at a high temperature by mixing a lens made of plastic and a lens made of glass may be suppressed, while reducing the weight of the module and increasing the unit price due to the increased in material cost. According to an embodiment of the invention, deformation of a lens or deterioration of resolving power at a high temperature may be suppressed, and stable optical performance may be implemented even when the ambient temperature changes.

According to an embodiment of the invention, the optical reliability of the vehicle optical system and camera module can be improved. In addition, the reliability of the camera module and the vehicle camera device having the same may be improved.

### DESCRIPTION OF DRAWINGS

FIG. 1 is an example of a plan view of a vehicle to which a camera module or optical system according to an embodiment of the invention is applied.

FIG. 2 is a side cross-sectional view showing an optical system for a vehicle according to a first embodiment of the invention.

FIG. 3 is a graph showing relative illumination according to image height in the optical system of FIG. 2.

FIG. 4 is a diagram showing horizontal and vertical FOVs according to aberration characteristics in the optical system of FIG. 2.

FIGS. 5 to 7 are graphs showing a modulation transfer function (MTF) of diffraction at low temperature, room temperature, and high temperature in the optical system of FIG. 2, and are graphs showing modulation of luminance according to spatial frequency.

FIGS. 8 to 10 are graphs showing a diffraction MTF at low temperature, room temperature, and high temperature in the optical system of FIG. 2, and are graphs showing a luminance ratio according to a defocusing position.

FIGS. 11 to 13 are graphs of astigmatic field curves and distortion in the optical system of FIG. 2 at low temperature, room temperature, and high temperature.

FIG. 14 is a side cross-sectional view showing an optical system for a vehicle according to a second embodiment of the invention.

FIG. 15 is a graph showing relative illumination according to image height in the optical system of FIG. 14.

FIG. 16 is a diagram showing horizontal and vertical FOVs according to aberration characteristics in the optical system of FIG. 14.

FIGS. 17 to 19 are graphs showing the diffraction MTF at low temperature, room temperature, and high temperature in the optical system of FIG. 14, and are graphs showing the luminance ratio (modulation) according to the spatial frequency.

FIGS. 20 to 22 are graphs showing the diffraction MTF at low temperature, room temperature, and high temperature in the optical system of FIG. 14, and are graphs showing the luminance ratio according to the defocusing position.

FIGS. 23 to 25 are views showing astigmatic field curves and distortion graphs at low temperature, room temperature, and high temperature in the optical system of FIG. 14.

FIG. 26 is a side cross-sectional view showing an optical system for a vehicle according to a third embodiment of the invention.

FIG. 27 is a graph showing relative illumination according to image height in the optical system of FIG. 26.

FIG. 28 is a diagram showing horizontal and vertical FOVs according to aberration characteristics in the optical system of FIG. 26.

FIGS. 29 to 31 are graphs showing the diffraction MTF at low temperature, room temperature, and high temperature in the optical system of FIG. 26, and are graphs showing the luminance ratio according to the defocusing position.

FIGS. 32 to 34 are graphs showing the diffraction MTF at low temperature, room temperature, and high temperature in the optical system of FIG. 26, and are graphs showing the luminance ratio according to the defocusing position.

FIGS. 35 to 37 are diagrams showing astigmatic field curves and distortion graphs at low temperature, room temperature, and high temperature in the optical system of FIG. 26.

FIG. 38 is a side cross-sectional view showing an optical system for a vehicle according to a fourth embodiment of the invention.

FIG. 39 is a graph showing relative illumination according to image height in the optical system of FIG. 38.

FIG. 40 is a diagram showing horizontal and vertical FOVs according to aberration characteristics in the optical system of FIG. 38.

FIGS. 41 to 43 are graphs showing the diffraction MTF at low temperature, room temperature, and high temperature in the optical system of FIG. 38, and are graphs showing the luminance ratio according to the defocusing position.

FIGS. 44 to 46 are graphs showing the diffraction MTF at low temperature, room temperature, and high temperature in the optical system of FIG. 38, and are graphs showing the luminance ratio according to the defocusing position.

FIGS. 47 to 49 are graphs of astigmatic field curves and distortion in the optical system of FIG. 38 at low temperature, room temperature, and high temperature.

FIG. 50 is a side cross-sectional view showing an optical system for a vehicle according to a fifth embodiment of the invention.

FIG. 51 is a graph showing relative illumination according to image height in the optical system of FIG. 50.

FIG. 52 is a diagram illustrating horizontal and vertical FOVs according to aberration characteristics in the optical system of FIG. 50.

FIGS. 53 to 55 are graphs showing the diffraction MTF at low temperature, room temperature, and high temperature in the optical system of FIG. 50, and are graphs showing the luminance ratio according to the defocusing position.

FIGS. 56 to 58 are graphs showing the diffraction MTF at low temperature, room temperature, and high temperature in the optical system of FIG. 50, and are graphs showing the luminance ratio according to the defocusing position.

FIGS. 59 to 61 are graphs of astigmatic field curves and distortion in the optical system of FIG. 50 at low temperature, room temperature, and high temperature.

FIG. 62 is a side cross-sectional view illustrating an example of a camera module having an optical system according to an embodiment(s) of the invention.

FIG. 63 is a side cross-sectional view illustrating another example of a camera module having an optical system according to an embodiment(s) of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology. Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. In addition, several embodiments described below can be combined with each other unless specifically stated that they cannot be combined with each other. In addition, unless otherwise specified, descriptions for other embodiments may be applied to missing parts in the description of any one of several embodiments.

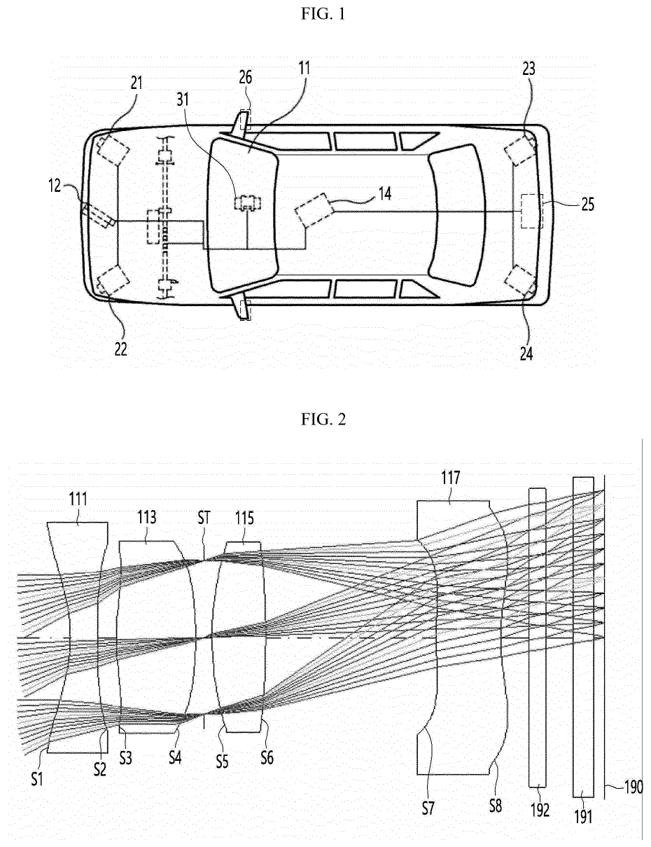

FIG. 1 is an example of a plan view of a vehicle to which a camera module or optical system according to an embodiment of the invention is applied. Referring to FIG. 1, a vehicle camera system according to an embodiment of the invention includes an image generating portion 11, a first information generating portion 12, and a second information generating portion 21, 22, 23, 24, 25, and 26, and a control portion 14. The image generating portion 11 may include at least one camera module 31 disposed in the vehicle, and may capture the front of the vehicle and/or the driver to generate a front image of the vehicle or an image inside the vehicle. The image generating portion 11 may generate an image of the surroundings of the own vehicle by capturing not only the front of the own vehicle but also the surroundings of the own vehicle in one or more directions using the camera module 31. Here, the front image and the surrounding image may be digital images, and may include color images, black and white images, and infrared images. In addition, the front image and the surrounding image may include still images and moving images. The image generating portion 11 provides the driver's image, front image, and surrounding image to the control portion 14. Subsequently, the first information generating portion 12 may include at least one radar or/and camera disposed in the own vehicle, and detects the front of the own vehicle to generate first detection information. Specifically, the first information generating portion 12 is disposed in the own vehicle and generates first detection information by detecting the location and speed of vehicles located in front of the own vehicle, presence and location of pedestrians, and the like.

The first detection information generated by the first information generator 12 may be used to maintain a constant distance between the host vehicle and the preceding vehicle, and the stability of the vehicle may be improved in certain preset cases, such as when the driver wants to change the driving lane of host vehicle or when parking in reverse. The first information generating portion 12 provides the first sensing information to the control portion 14. The second information generating portions 21, 22, 23, 24, 25, and 26 generate a second sensing information by sensing each side of the host vehicle based on the front image generated by the image generating portion 11 and the first detection information generated by the first information generating portion 12. Specifically, the second information generating portions 21, 22, 23, 24, 25, and 26 may include at least one radar or/and camera disposed in the own vehicle, and may sense a position and a speed of the vehicles positioned on a side of the own vehicle or capture an image. Here, the second information generating portions 21, 22, 23, 24, 25, and 26 may be disposed at both front corners, side mirrors, and rear center and rear corners of the vehicle, respectively.

Such a vehicle camera system may include a camera module having an optical system described in the following embodiment(s), and provide or process information to a user using information obtained through the front, rear, each side or corner area of the vehicle. to protect vehicles and objects from autonomous driving or surrounding safety.

A plurality of optical systems of the camera module according to an exemplary embodiment of the invention may be mounted in a vehicle in order to enhance safety regulation, self-driving function, and convenience. In addition, the optical system of the camera module is applied to a vehicle as a component for controlling a lane keeping assistance system (LKAS), a lane departure warning system (LDWS), and a driver monitoring system (DMS). Such a camera module for a vehicle may realize stable optical performance even when the ambient temperature changes and provides a module with a competitive price, thereby securing reliability of vehicle components.

In the description of the invention, a first lens means the lens closest to the object side, and a last lens means the lens closest to the image side (or sensor-side surface). The last lens may include a lens adjacent to the image sensor. Unless otherwise specified in the description of the invention, the portions for the radius, thickness/distance, TTL, etc. of the lens are all mm and are measured based on the optical axis. In this specification, the shape of the lens is shown based on the optical axis of the lens. For example, that an object-side surface of the lens is convex or concave means that the object-side surface of the lens is convex or concave around the optical axis, but does not mean that the object-side surface of the lens is convex or concave in the optical axis. Therefore, even when it is described that the object-side surface of the lens is convex, a portion around the optical axis on the object-side surface of the lens may be concave or vice versa. Also, the “object-side surface” may refer to a surface of a lens facing the object side based on an optical axis, and the “image-side surface” may refer to a surface of a lens facing an imaging surface based on an optical axis. The object side may be an object-side surface or an incident side surface through which light is incident, and the image-side surface may mean a sensor side surface or an emission side surface through which light is emitted.

An optical system according to an embodiment of the invention may include a lens made of glass and a lens made of plastic. The optical system may include at least one glass lens and at least three plastic lenses. Among the lenses in the optical system, a ratio of the number of lenses made of glass to lenses made of plastic may be 3:1. Of the total lenses in the optical system, lenses made of glass may account for 30% or less, and lenses made of plastic may account for 50% or more, for example, 75% or more of the total lenses.

In the optical system according to an embodiment of the invention, at least four lenses may be stacked, and for example, four to six lenses may be stacked. The optical system may include at least four solid lenses, and the solid lenses may include a plastic lens and a glass lens. In the optical system according to an embodiment of the invention, the number of lenses made of plastic may be greater than the number of lenses made of glass. Accordingly, a lens having an aspherical surface and a lens having a spherical surface may be mixed, and a change in properties of a material according to temperature may be suppressed and a deterioration in optical performance (MTF) may be inhibited. Such an optical system may be applied to a camera module for monitoring a driver in a mobile device such as a vehicle.

### First Embodiment

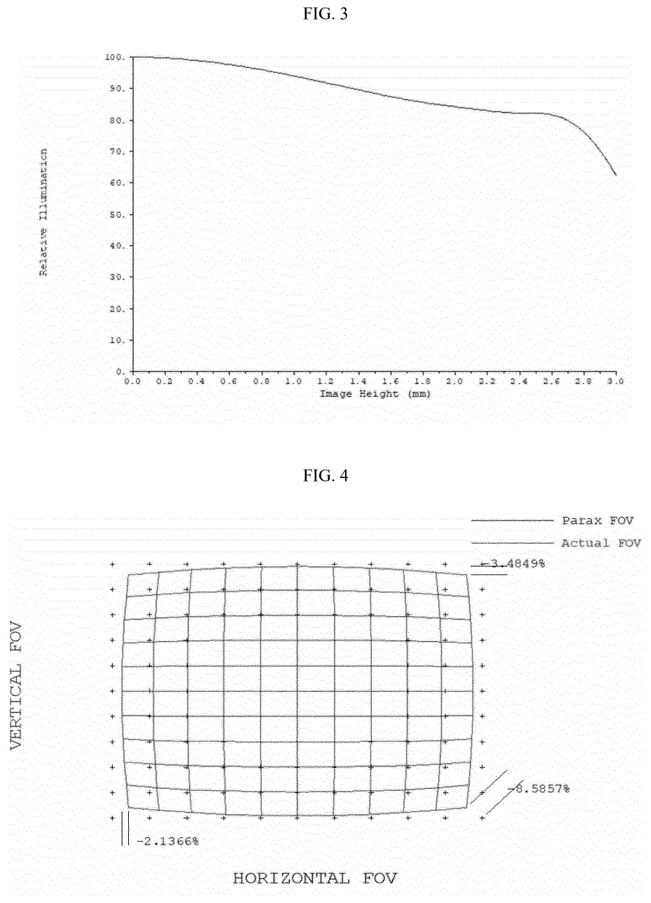

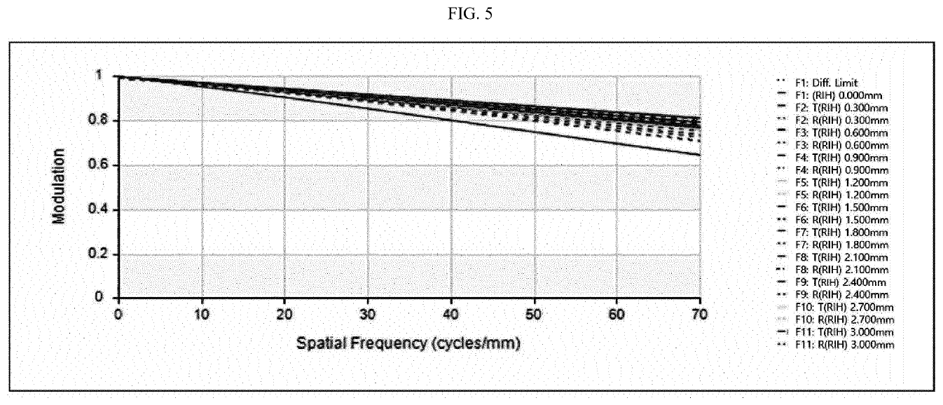

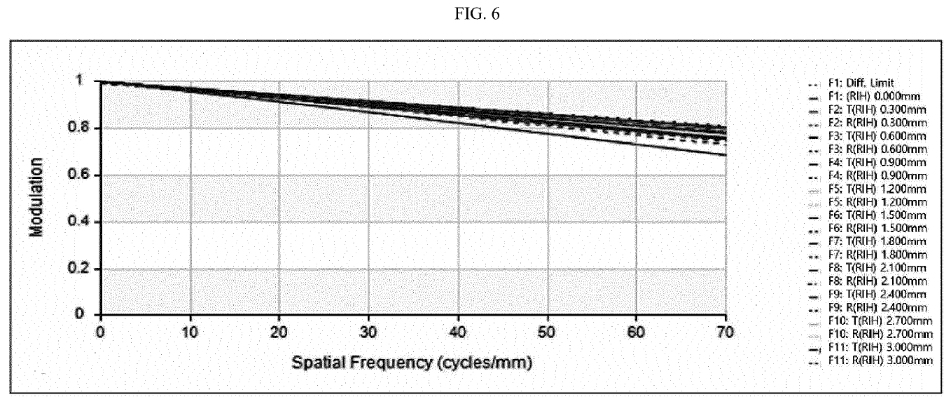

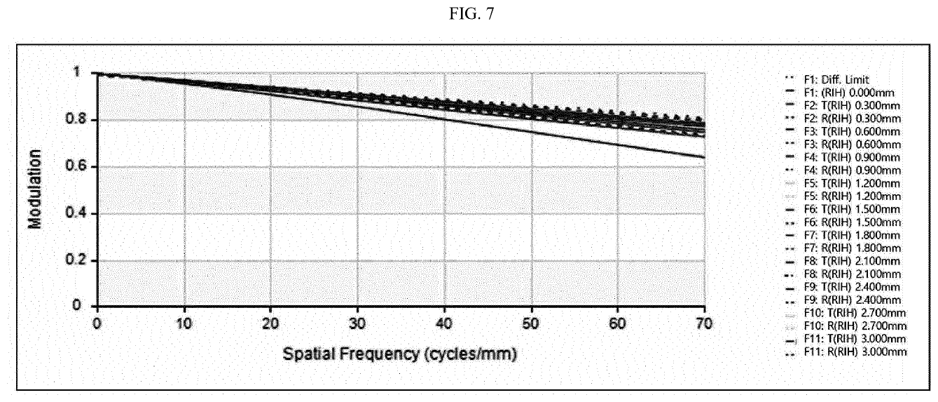

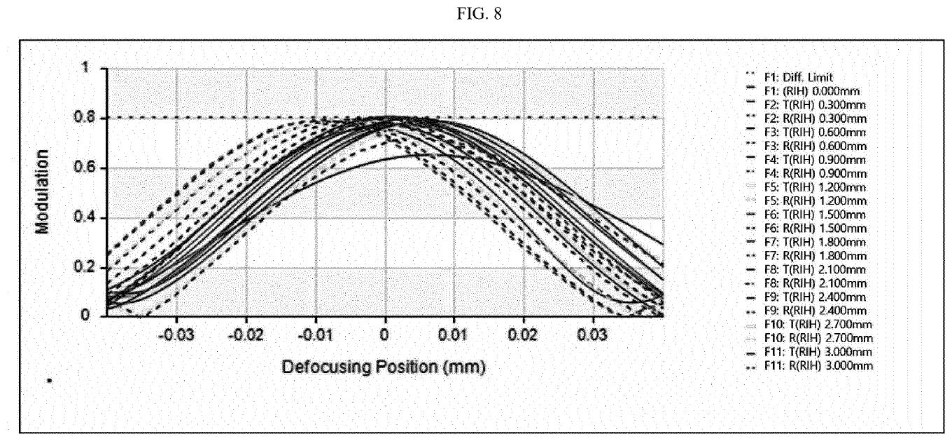

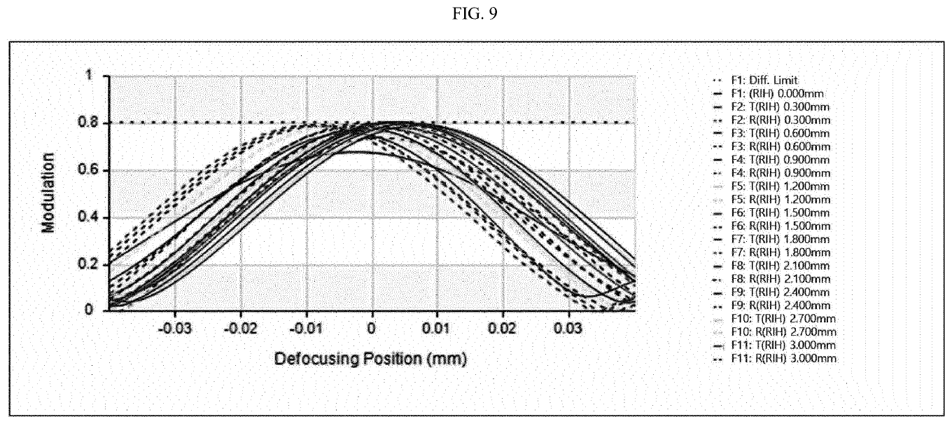

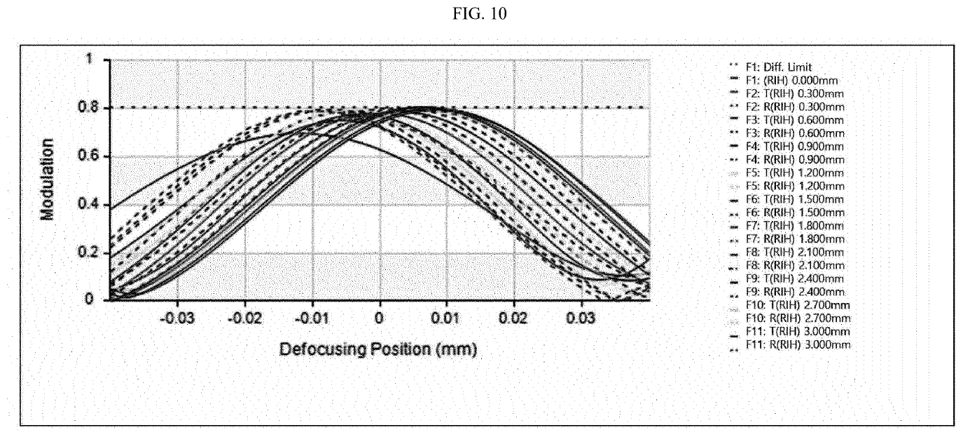

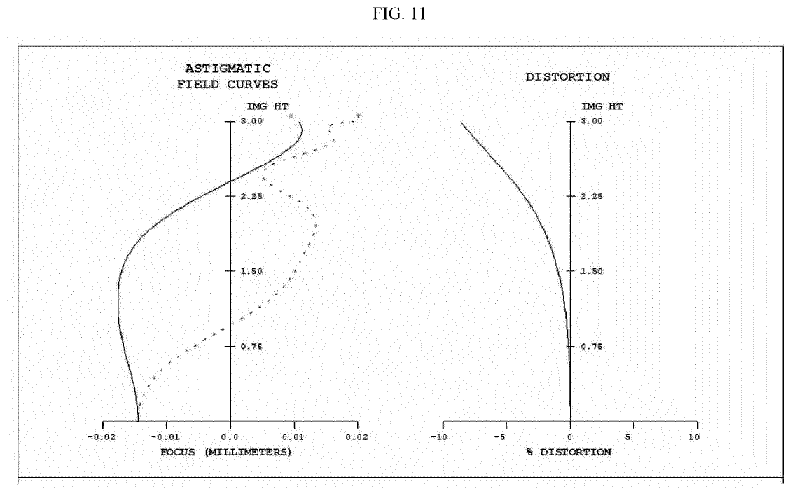

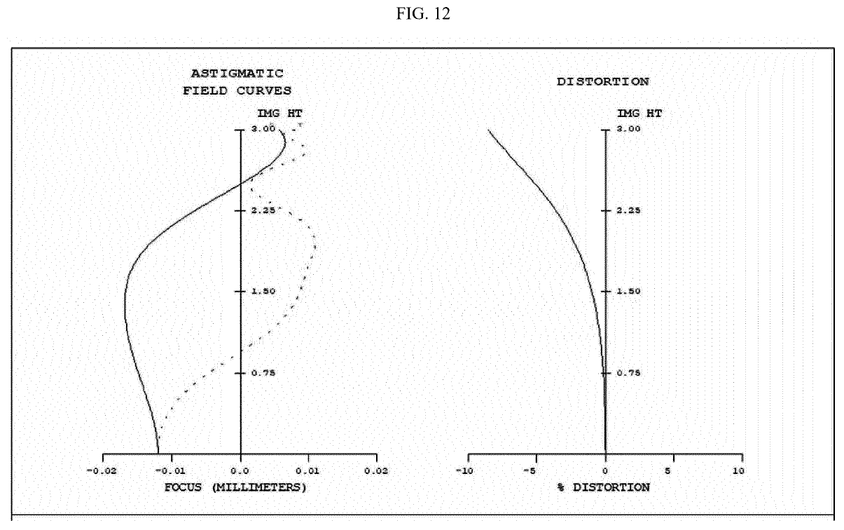

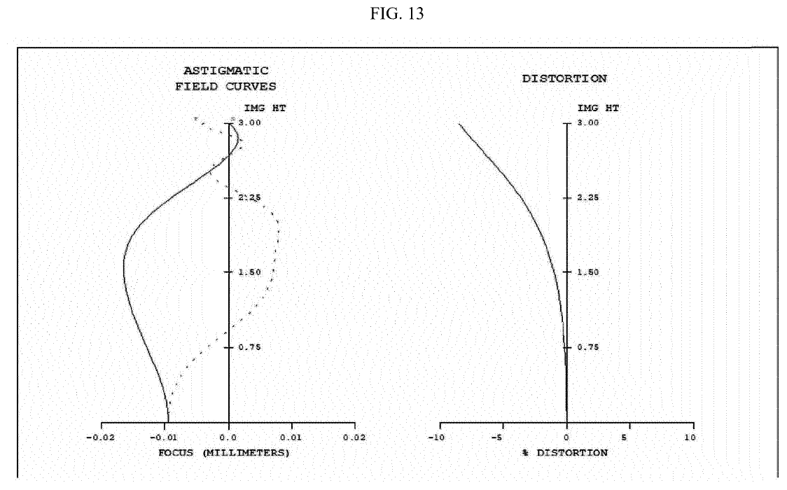

FIG. 2 is a side cross-sectional view showing an optical system for a vehicle according to a first embodiment of the invention, FIG. 3 is a graph showing relative illumination according to image height in the optical system of FIG. 2, FIG. 4 is a diagram showing horizontal and vertical FOVs according to aberration characteristics in the optical system of FIG. 2, FIGS. 5 to 7 are graphs showing a diffraction MTF at low temperature, room temperature, and high temperature in the optical system of FIG. 2, and are graphs showing modulation of luminance according to spatial frequency, FIGS. 8 to 10 are graphs showing a diffraction MTF at low temperature, room temperature, and high temperature in the optical system of FIG. 2, and are graphs showing a luminance ratio according to a defocusing position, and FIGS. 11 to 13 are graphs of astigmatic field curves and distortion in the optical system of FIG. 2 at low temperature, room temperature, and high temperature.

Referring to FIG. 2, an optical system according to a first embodiment of the invention may include a first lens 111, a second lens 113, a third lens 115, and a fourth lens 117 stacked along an optical axis in a direction from an object side to a sensor side or an image side. The optical system or a camera module having the same may include an image sensor 190, and a cover glass 191 and an optical filter 192 between the image sensor 190 and the lenses. The optical system may include an aperture stop ST for adjusting the amount of incident light. The aperture stop ST may be disposed between the second lens 113 and the third lens 115 or between the third lens 115 and the fourth lens 117. In the aperture stop ST, the circumference of the sensor-side surface of the second lens 113 and the object-side or sensor-side surface of the third lens 115 may function as the aperture stop.

A lens group disposed on the object side based on the aperture ST may be divided into a first lens group and a lens group disposed on the sensor side based on the aperture ST may be divided into a second lens group. That is, the first lens group may include at least two lenses on the object side, and the second lens group may include at least two lenses between the first lens group and the image sensor 190.

The first lens 111 is a lens closest to the subject and may include a plastic material. The first lens 111 includes an object-side first surface S1 and a sensor-side second surface S2, and both the first surface S1 and the second surface S2 may be aspherical surface. The first lens 111 may have negative refractive power and a refractive index of 1.6 or less. The first lens 111 may have a refractive index lower than that of the third lens 115. Here, the refractive index may be a refractive index value at a wavelength of 940 nm.

The first surface S1 of the first lens 111 may be concave toward the sensor, and the second surface S2 may be concave toward the object. An outer circumference of the second surface S2 may include a flat effective region. Expressed as an absolute value, the radius of curvature of the first surface S1 may be smaller than the radius of curvature of the second surface S2, and may be 7 mm or less, for example, in the range of 2 mm to 7 mm. The radius of curvature of the first surface S1 may be the smallest among the object-side surface and the sensor-side surface of the lenses of the optical system. When the first lens 111 is exposed to light from the inside or outside of the vehicle in the camera module, discoloration may be inhibited by placing it in a plastic material. A distance between the first lens 111 and the second lens 113 on the optical axis may be greater than a distance between the second lens 113 and the third lens 115 on the optical axis. The distance between the first lens 111 and the second lens 113 may be smaller than a center thickness of the first lens 111. The center thickness of the first lens 111 may be thinner than the center thickness of the second lens 113, for example, 0.8 mm or less, or may be in the range of 0.2 mm to 0.8 mm.

An Abbe number Vd of the first lens 111 may be the largest among lenses in the optical system. For example, the Abbe number Vd of the first lens 111 may be 50 or more. Expressed as an absolute value, the focal length of the first lens 111 may be smaller than the focal length of the fourth lens 117, and may be 10 mm or less, for example, in the range of 3 mm to 10 mm. An effective diameter through which light is incident on the first lens 111 may be larger than the effective diameters of the other second and third lenses 113 and 115. The first lens 111 may be a concave lens.

The second lens 113 may be made of a plastic material. The second lens 113 has a positive (+) refractive power and may be formed of a material having a refractive index of 1.6 or more or a refractive index in the range of 1.6 to 1.7. The second lens 113 may be disposed between the first lens 111 and the third lens 115. The second lens 113 includes an object-side third surface S3 and a sensor-side fourth surface S4, and both the third surface S3 and the fourth surface S4 may be aspherical surface. The third surface S3 may be convex toward the object, and the fourth surface S4 may be convex toward the sensor. Expressed as an absolute value, the radius of curvature of the third surface S3 may be smaller than the radius of curvature of the fourth surface S4, for example, 10 mm or less. When expressed as an absolute value, the radius of curvature of the fourth surface S4 may be larger than the radius of curvature of the first surface S1 and smaller than the radius of curvature of the second surface S2. The distance between the second lens 113 and the third lens 115 on the optical axis may be less than 1 mm. The center thickness of the second lens 113 may be 3 times or more than 4 times the distance between the second and third lenses 113 and 115, and may be 1.2 mm or more, or may be in the range of 1.2 mm to 1.7 mm. The Abbe number Vd of the second lens 113 may be less than 30, for example, in the range of 10 to 29. The focal length of the second lens 113 may be 10 mm or less. The second lens 113 may be a convex lens. The first and second lenses 111 and 113 are disposed of a plastic material on the object side to inhibit a decrease in the amount of light incident through the object side and to improve aberration of incident light.

The third lens 115 may be made of glass. The third lens 115 has positive (+) refractive power and may be formed with a refractive index of 1.65 or more or a refractive index in the range of 1.65 to 1.8. The refractive index of the third lens 115 may be the highest in the optical system. The third lens 115 may be disposed between the second and fourth lenses 113 and 117. The third lens 115 may include a fifth surface S5 on the object side and a sixth surface S6 on the sensor side, and both of the fifth surface S5 and the sixth surface S6 are spherical surfaces. The fifth surface S5 may be convex toward the object, and the sixth surface S6 may be convex. Expressed as an absolute value, the radius of curvature of the fifth surface S5 may be smaller than the radius of curvature of the sixth surface S6, and their difference may be 10 mm or more.

A distance between the third lens 115 and the fourth lens 117 on the optical axis may be greater than the distance between the second and third lenses 113 and 115 on the optical axis. The distance between the third lens 115 and the fourth lens 117 may be larger than the thickness of the center of the third lens 115, for example, twice or more than the center thickness of the third lens 115. The center thickness of the third lens 115 may be 1.5 mm or less, for example, in the range of 0.7 mm to 1.5 mm. The Abbe number Vd of the third lens 115 may be greater than the Abbe number of the fourth lens 117 and may be less than 30, for example, in the range of 10 to 29. Expressed as an absolute value, the focal length of the third lens 115 may be greater than that of the first and second lenses 111 and 113 and may be 10 mm or less. The third lens 115 may be a convex lens. Here, the aperture stop ST may be disposed on the circumference between the second lens 113 and the third lens 115, and may be disposed on the circumference between the plastic lens and the glass lens.

The fourth lens 117 is a lens closest to the image sensor 190 and may be made of a plastic material. The fourth lens 117 has negative (−) refractive power and may be formed with a refractive index of 1.7 or less or a refractive index in the range of 1.6 to 1.7. The fourth lens 117 may be disposed between the third lens 115 and the image sensor 190. The fourth lens 117 includes an object-side seventh surface S7 and a sensor-side eighth surface S8, and the seventh surface S7 and the eighth surface S8 may be both aspherical surfaces. The seventh surface S7 may be convex toward the object, and the eighth surface S8 may be concave. The radius of curvature of the seventh surface S7 may be greater than the radius of curvature of the eighth surface S8 and may be smaller than the radius of curvature of the second surface S2, and may be, for example, greater than or equal to 8 mm or in the range of 8 mm to 20 mm. At least one or both of the seventh surface S7 and the eighth surface S8 of the fourth lens 117 may have at least one inflection point around the center portion thereof.

The center thickness of the fourth lens 117 may be thicker than the center thickness of the third lens 115, and may be 1.5 mm or less, for example, in the range of 1.0 mm to 1.5 mm, and Abbe number Vd of the fourth lens 117 may be the same as the Abbe number of the second lens 113, and may be less than 30, for example, in the range of 10 to 29. When the focal length of the fourth lens 117 is obtained as an absolute value, it may be 20 mm or less, for example, in the range of 10 mm to 20 mm. Each of the lenses 111, 113, 115, and 117 may include an effective region having an effective diameter through which light is incident, and a flange portion outside the effective region, which is a non-effective region. The non-effective region may be a region in which light is blocked by a spacer or a light blocking film. Here, the ratio of the lenses disposed on the sensor side and the lenses disposed on the object side with respect to the aperture ST may be 1:1.

The image sensor 190 may perform a function of converting light passing through lenses into image data. Here, a housing or lens holder may be disposed outside the optical system, and a sensor holder may be disposed below to surround the image sensor 190 and protect the image sensor 190 from external foreign substances or shocks. The image sensor 190 may be any one of a charge coupled device (CCD), complementary metal-oxide Semiconductor (CMOS), CPD, and CID. When the number of image sensors 190 is plural, one may be a color (RGB) sensor and the other may be a black and white sensor. The diagonal size of the image sensor 190 may be greater than or equal to 4 mm, for example, 4 mm to 10 mm or 4.5 mm to 7.5 mm. The optical filter 192 may be disposed between the fourth lens 117 and the image sensor 190. The optical filter 192 may filter light corresponding to a specific wavelength range with respect to light passing through the lenses 111, 113, 115, and 117. The optical filter 192 may be an infrared (IR) blocking filter that blocks infrared rays or an ultraviolet (UV) blocking filter that blocks ultraviolet rays, but the embodiment is not limited thereto. The optical filter 192 may be disposed on the image sensor 190.

The cover glass 191 is disposed between the optical filter 192 and the image sensor 192, protects an upper portion of the image sensor 192, and may inhibit deterioration in reliability of the image sensor 192.

The camera module for vehicle according to an embodiment of the invention may include or remove a driving member (not shown) around the optical system. That is, since the optical system is disposed in the vehicle, it is difficult to control the focus by moving the lens barrel supporting the optical system on an optical axis direction or/and a direction perpendicular to the optical axis direction with the driving member, so the driving member may be removed. The driving member may be an actuator or a piezoelectric element for an auto focus (AF) function or/and an optical image stabilizer (OIS) function. Here, the lens barrel supporting the optical system may include a metal material, for example, an aluminum material. In the optical system according to the first embodiment of the invention, the angle of view (diagonal line) may be 70 degrees or less, for example, in the range of 55 degrees to 70 degrees. An effective focal length may be 8 mm or less, such as a range of 4 mm to 8 mm or a range of 5 mm to 6 mm. F number of the optical system or camera module may be 2.4 or less, for example, in the range of 1.8 to 2.4 or in the range of 2 to 2.3. A chief ray angle (CRA) may be less than or equal to 30 degrees, for example, in the range of 20 to 30 degrees. In the optical system, a distance (TTL) between the image sensor 190 and the vertex of the first lens 111 may be 11 mm or less. In addition, the wavelength of light used in the optical system may be in the range of 870 nm to 1000 nm. When the temperature ranges from low temperature (e.g., −40 degrees) to high temperature (e.g., 85 degrees), the MTF reduction may be 10% or less.

In the optical system according to the first embodiment of the invention, since the material of the lens barrel or the lens holder supporting the lenses is a metal material, for example, aluminum having high heat dissipation properties, heat dissipation properties of the lenses may be improved. Accordingly, the proportion of lenses made of plastic in the optical system may be higher than that of lenses made of glass.

Table 1 shows lens data in the optical system of FIG. 1.

TABLE 1

| | | | | | | Abbe | | | |
|---|---|---|---|---|---|---|---|---|---|
| | | | Curvature | Thickness/ | Refractive | number | | Focal | Semi- |
| | Surface | Shape | radius | distance | Index | (Vd) | Diopter | length | aperture |
| Lens 1 | S1 | Asphere | −3.417 | 0.500 | 1.536 | 56.107 | −188.890 | −5.317 | 2.121 |
| | S2 | Asphere | 17.948 | 0.350 | | | | | 1.829 |
| Lens 2 | S3 | Asphere | 5.730 | 1.474 | 1,644 | 19.246 | 182.642 | 5.475 | 1.769 |
| | S4 | Asphere | −8.232 | 0.300 | | | | | 1.744 |
| Stop | | Flat | 1.E+18 | | | | | | |
| Lens 3 | S5 | Sphere | 6.779 | 0.993 | 1.726 | 25.047 | 144.078 | 6.941 | 1.691 |
| | S6 | Sphere | −18.414 | 3.159 | | | | | 1.750 |
| Lens 4 | S7 | Asphere | 12.184 | 1.196 | 1.644 | 19.246 | −75.520 | −13.242 | 1.972 |
| | S8 | Asphere | 4.822 | 0.529 | | | | | 2.520 |
| BPF | Sa | Flat | 1.E+18 | 0.400 | 1.508 | 64.166 | | | |
| | Sb | Flat | 1.E+18 | 1.000 | | | | | |
| | Sc | Flat | 1.E+18 | 0.400 | 1.508 | 64.166 | | | |
| Cover glass | Sd | Flat | 1.E+18 | 0.200 | | | | | |
| CIS | | Flat | 1.E+18 | 0.000 | | | | | |

In Table 1, the refractive indices of the first to fourth lenses 111, 113, 115, and 117 are the refractive indices at 940 nm, and the Abbe numbers Vd of the second, third, and fourth lenses 111, 115, and 117 at d-line (587 nm) may be less than 30, and the Abbe number Vd of the first lens 111 may be 50 or more. Semi-aperture represents an effective radius (mm) of each lens. The Sa and Sb may be the incident side and the exit surface of the optical filter, and Sc and Sd may be the incident side and the exit surface of the cover glass. CIS is an image sensor. When expressed as absolute values, values of curvature radius (mm), thickness (mm), center distance (mm) between lenses, refractive index, Abbe number, and focal length (mm) may also be expressed by a relational expression based on Table 1 above. For example, the diopter may represent the relational expression in the order of the first lens>second lens>third lens>fourth lens. Table 2 is the aspheric coefficient of each surface of each lens in the optical system of FIG. 1.

TABLE 2

| | | Asphereical coefficient | | | | | | | | | |
|---|---|---|---|---|---|---|---|---|---|---|---|
| Item | Surface | K | A | B | C | D | E | F | G | H | J |
| Lens 1 | S1 | −0.00140 | 0.01987 | −0.00115 | 0.00004 | 0.00001 | 8.37E−08 | 2.32E−08 | 3.32E−09 | −3.40E−10 | −4.58E−10 |
| | S2 | −0.70665 | −0.00180 | 0.00527 | −0.00126 | 0.00012 | 4.97E−07 | 1.90E−07 | 4.33E−08 | 3.33E−09 | −2.78E−09 |
| Lens 2 | S3 | −0.02153 | −0.02397 | 0.00350 | −0.00129 | 0.00009 | 2.54E−05 | −1.58E−05 | 4.48E−07 | 7.81E−07 | −1.32E−07 |
| | S4 | −0.03258 | −0.00742 | −0.00134 | 0.00021 | −0.00009 | −1.36E−06 | 4.96E−06 | −1.20E−06 | 2.27E−07 | −2.10E−08 |
| Lens 3 | S5 | | | | | | | | | | |
| | S6 | | | | | | | | | | |
| Lens 4 | S7 | −0.18562 | −0.02474 | −0.00357 | 0.00186 | −0.00074 | 5.54E−05 | 3.74E−05 | −5.97E−06 | −2.03E−06 | 4.29E−07 |
| | S8 | −0.01619 | −0.02086 | −0.00191 | 0.00103 | −0.00021 | 5.38E−06 | 3.67E−06 | −1.33E−07 | −7.97E−08 | 7.28E−09 |

FIG. 3 is a graph showing ambient light ratio or relative illumination according to image height in the optical system of FIG. 2, and it may be seen that relative illumination ratio of 55% or more, for example, 70% or more, appears from the center of the image sensor to the diagonal end. FIG. 4 is a diagram showing an actual FOV and a Parax FOV for a horizontal FOV (Field of View) and vertical FOV at room temperature (e.g., 22 degrees) in the optical system of FIG. 2. FIGS. 5 to 7 are graphs showing diffraction MTF (Modulation Transfer Function) at low temperature, room temperature, and high temperature in the optical system of FIG. 2, and are graphs showing luminance ratio (modulation) according to spatial frequency. FIGS. 8 to 10 are graphs showing diffraction MTF at low temperature, room temperature, and high temperature in the optical system of FIG. 2, and are graphs showing the luminance ratio according to the defocusing position. As shown in FIGS. 5 to 10, it may be seen that the lowering of the luminance modulation is hardly changed at 10% or less at a low temperature of −40 degrees, a room temperature of 20 degrees, and a high temperature of 85 degrees. As shown in FIGS. 11 to 13, it may be seen that in the optical system of FIG. 2, astigmatic field curves and distortion at low temperature, room temperature, and high temperature are #11 or less (1.0 filed). That is, as shown in FIGS. 5 to 13, it may be seen that the change in optical characteristic data according to the temperature change from low temperature to high temperature is not large, less than 10%.

### Second Embodiment

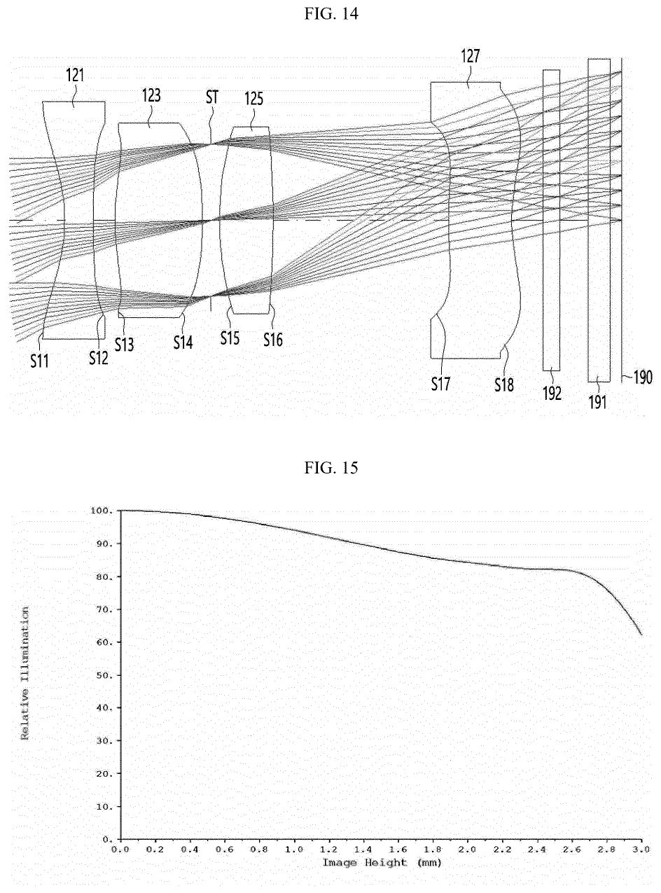

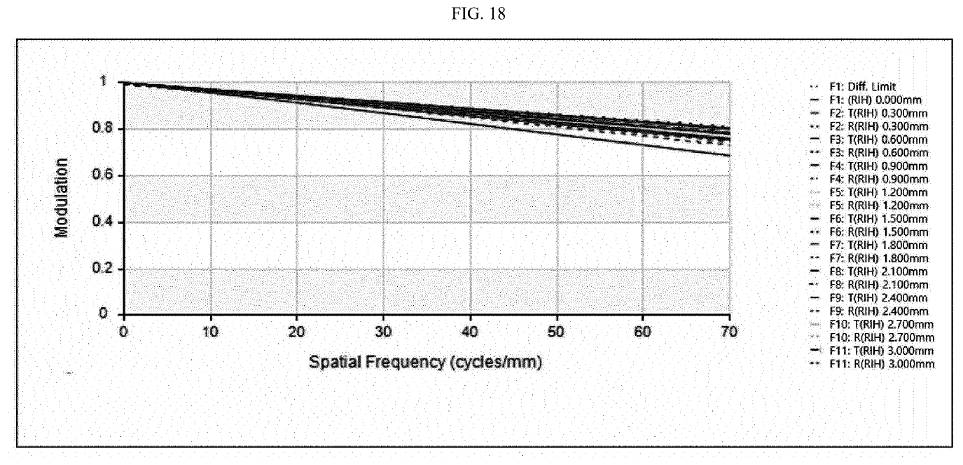

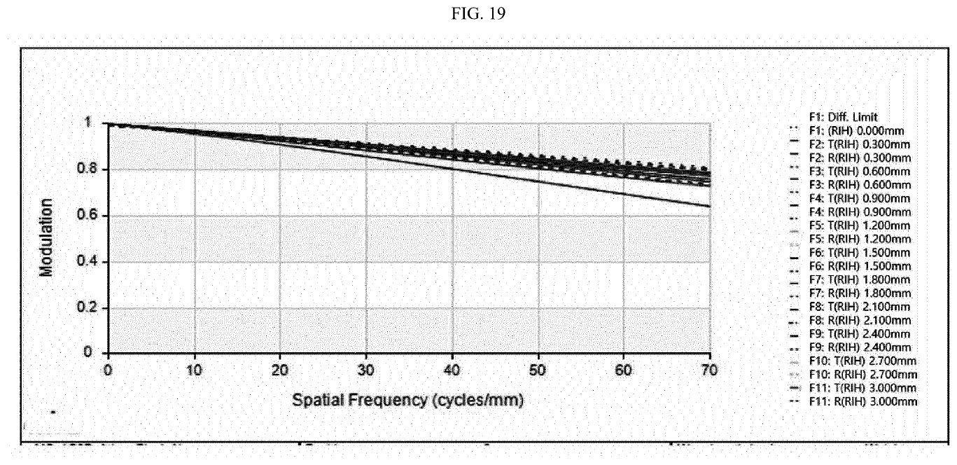

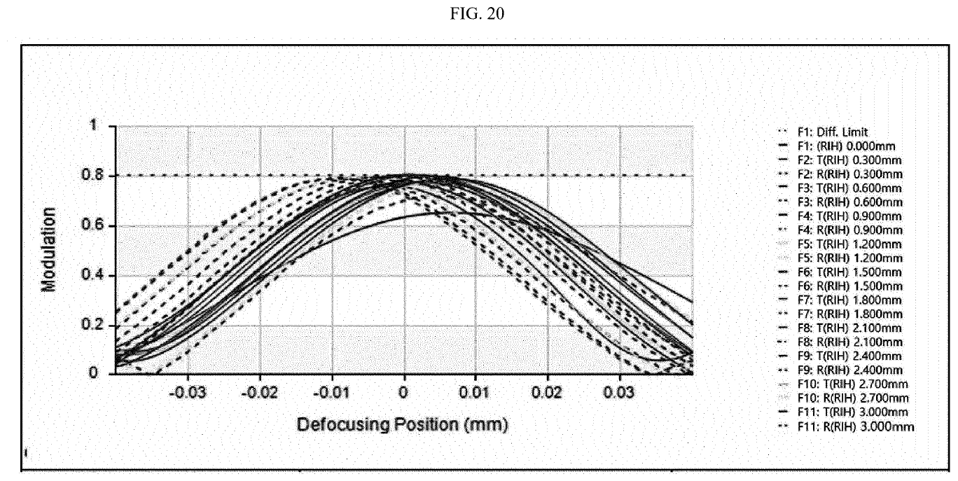

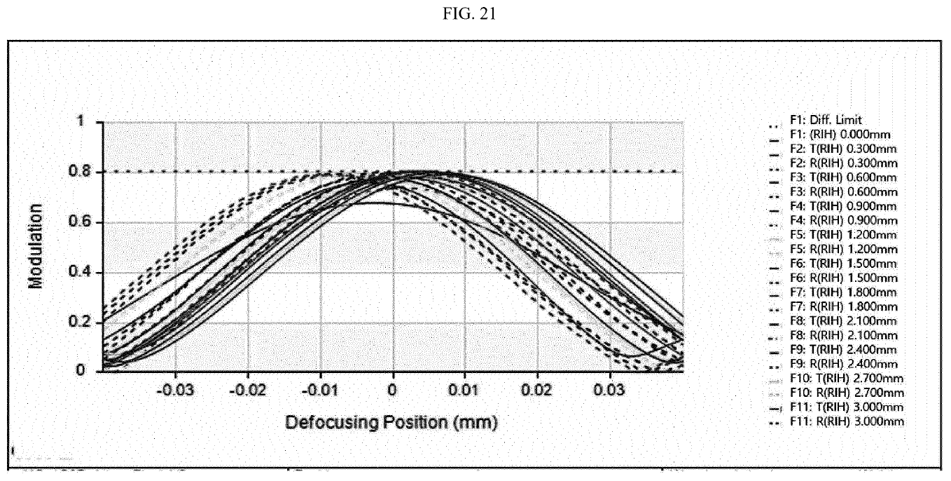

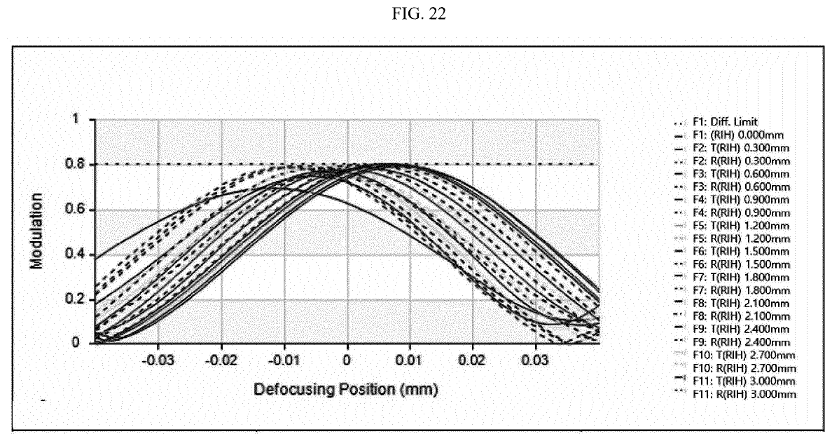

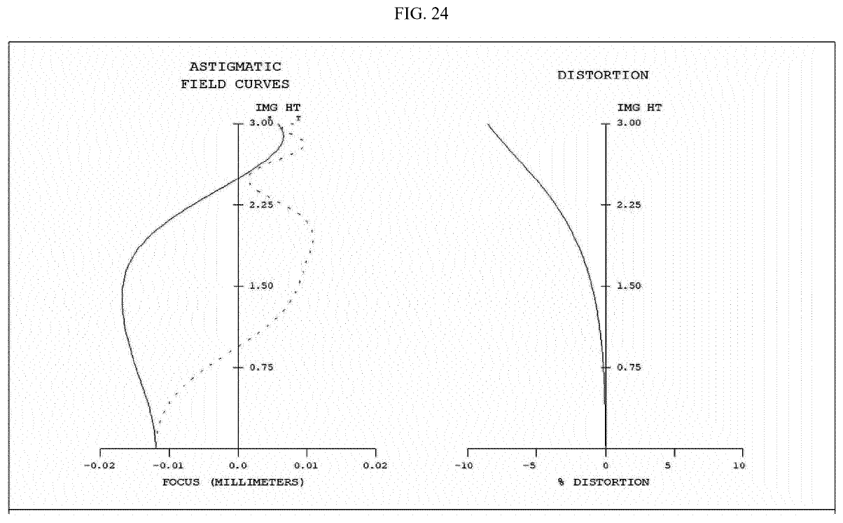

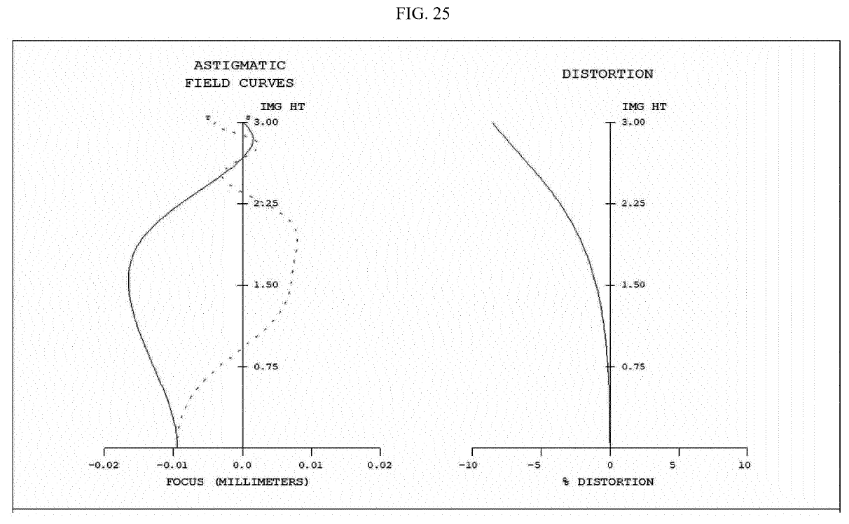

Referring to FIGS. 14 to 25 for the second embodiment. FIG. 14 is a side cross-sectional view showing an optical system for a vehicle according to a second embodiment of the invention. In describing the second embodiment, the same configuration as the first embodiment will be referred to the description of the first embodiment.

Referring to FIG. 14, the optical system according to the second embodiment of the invention may include a first lens 121, a second lens 123, a third lens 125, a fourth lens 127 stacked along an optical axis from the object side to the sensor side. The optical system or a camera module having the same may include an image sensor 190, a cover glass 191, and an optical filter 192 between the image sensor 190 and the lenses. In the optical system according to the second embodiment, a lens barrel or a lens holder may be made of a metal material, for example, aluminum.

The first lens 121 is a lens closest to the subject and may include a plastic material. The first lens 121 includes an object-side first surface S1 and a sensor-side second surface S2, and both of the first surface S1 and the second surface S2 may be aspherical surface. The first lens 121 may have negative refractive power and a refractive index of 1.6 or less. The first lens 121 may have a refractive index lower than that of the third lens 125. Here, the refractive index may be a refractive index value at a wavelength of 940 nm.

The first surface S1 of the first lens 121 may be concave toward the sensor side, and the second surface S2 may be concave toward the object. An outer circumference of the second surface S2 may include a flat effective region. Expressed as an absolute value, the radius of curvature of the first surface S1 may be smaller than the radius of curvature of the second surface S2, and may be 7 mm or less, for example, in the range of 2 mm to 7 mm. The radius of curvature of the first surface S1 may be the smallest among the object-side surface and the sensor-side surface of the lenses of the optical system. When the first lens 121 is exposed to light from the inside or outside of the vehicle in the camera module, discoloration may be inhibited by placing it in a plastic material. A distance between the first lens 121 and the second lens 123 on the optical axis may be greater than a distance between the second lens 123 and the third lens 125 on the optical axis. The distance between the first lens 121 and the second lens 123 may be smaller than a center thickness of the first lens 121. The center thickness of the first lens 121 may be thinner than the center thickness of the second lens 123, for example, 0.8 mm or less or may be in the range of 0.2 mm to 0.8 mm. The Abbe number Vd of the first lens 121 may be the largest among the lenses of the optical system. For example, the Abbe number Vd of the first lens 121 may be 50 or more. Expressed as an absolute value, the focal length of the first lens 121 may be smaller than the focal length of the fourth lens 127, and may be 10 mm or less, for example, in the range of 3 mm to 10 mm. An effective diameter through which light is incident from the first lens 121 may be larger than the effective diameters of the other second and third lenses 123 and 125. The first lens 121 may be a concave lens.

The second lens 123 may be made of a plastic material. The second lens 123 has a positive (+) refractive power and may be formed of a material having a refractive index of 1.6 or more or a refractive index in the range of 1.6 to 1.7. The second lens 123 may be disposed between the first lens 121 and the third lens 125. The second lens 123 includes an object-side third surface S3 and a sensor-side fourth surface S4, and both of the third surface S3 and the fourth surface S4 may be aspherical surface. The third surface S3 may be convex toward the object, and the fourth surface S4 may be convex toward the sensor side. Expressed as an absolute value, the radius of curvature of the third surface S3 may be smaller than the radius of curvature of the fourth surface S4, for example, 10 mm or less. When expressed as an absolute value, the radius of curvature of the fourth surface S4 may be larger than the radius of curvature of the first surface S1 and smaller than the radius of curvature of the second surface S2. The distance between the second lens 123 and the third lens 125 on the optical axis may be less than 1 mm. The center thickness of the second lens 123 may be 3 or 4 times the distance between the second and third lenses 123 and 125, and may be 1.2 mm or more, or may range from 1.2 mm to 1.7 mm. The Abbe number Vd of the second lens 123 may be less than 30, for example, in the range of 10 to 29. The focal length of the second lens 123 may be 10 mm or less. The second lens 123 may be a convex lens. The first and second lenses 121 and 123 are disposed of a plastic material on the object side to inhibit a decrease in the amount of light incident through the object side and to improve aberration of incident light.

The third lens 125 may be made of glass. The third lens 125 has positive (+) refractive power and may be formed with a refractive index of 1.65 or more or a refractive index in the range of 1.65 to 1.8. The refractive index of the third lens 125 may be the highest in the optical system. The third lens 125 may be disposed between the second and fourth lenses 123 and 127. The third lens 125 includes a fifth surface S5 on the object side and a sixth surface S6 on the sensor side, and both of the fifth surface S5 and the sixth surface S6 may be spherical surfaces. The fifth surface S5 may be convex toward the object, and the sixth surface S6 may be convex. Expressed as an absolute value, the radius of curvature of the fifth surface S5 may be smaller than the radius of curvature of the sixth surface S6, and the difference may be 10 mm or more. The distance between the third lens 125 and the fourth lens 127 on the optical axis may be larger than the distance between the second and third lenses 123 and 125 on the optical axis. The distance between the third lens 125 and the fourth lens 127 may be larger than the center thickness of the third lens 125, for example, twice or more than the center thickness of the third lens 125. The center thickness of the third lens 125 may be 1.5 mm or less, for example, in the range of 0.7 mm to 1.5 mm. The distance between the third lens 125 and the fourth lens 127 may be the largest among distances between lenses in the optical system, and may be, for example, 2.5 mm or more.

The Abbe number Vd of the third lens 125 may be greater than the Abbe number of the fourth lens 127, and may be less than 30, for example, in the range of 10 to 29. Expressed as an absolute value, the focal length of the third lens 125 may be greater than that of the first and second lenses 121 and 123 and may be 10 mm or less. The third lens 125 may be a convex lens. Here, the aperture stop ST may be disposed on the circumference between the second lens 123 and the third lens 125, and may be disposed on the circumference between the plastic lens and the glass lens.

The fourth lens 127 is a lens closest to the image sensor 190 and may be made of a plastic material. The fourth lens 127 has negative (−) refractive power and may be formed with a refractive index of 1.7 or less or a refractive index in the range of 1.6 to 1.7. The fourth lens 127 may be disposed between the third lens 125 and the image sensor 190. The fourth lens 127 includes an object-side seventh surface S7 and a sensor-side eighth surface S8, and both the seventh surface S7 and the eighth surface S8 may be aspherical surfaces. The seventh surface S7 may be convex toward the object, and the eighth surface S8 may be concave. The radius of curvature of the seventh surface S7 may be greater than the radius of curvature of the eighth surface S8 and may be smaller than the radius of curvature of the second surface S2, and may be, for example, greater than or equal to 5 mm or in the range of 5 mm to 12 mm. At least one or both of the seventh surface S7 and the eighth surface S8 of the fourth lens 127 may have at least one inflection point around the center portion thereof. The center thickness of the fourth lens 127 may be thicker than the center thickness of the third lens 125, and may be 1.5 mm or less, for example, in the range of 1.0 mm to 1.5 mm, and an Abbe number Vd of the fourth lens 127 may be the same as an Abbe number of the second lens 123, and may be less than 30, for example, in the range of 10 to 29. When the focal length of the fourth lens 127 is obtained as an absolute value, it may be 20 mm or less, for example, in the range of 10 mm to 20 mm.

Each of the lenses 121, 123, 125, and 127 may include an effective region having an effective diameter through which light is incident and a flange portion outside the effective region, which is a non-effective region. The non-effective region may be a region in which light is blocked by a spacer or a light blocking film. Here, a ratio of the lens disposed on the sensor side and the lens disposed on the object side based on the aperture ST may be 1:1, and a ratio of the lens made of plastic to the lens made of glass in the optical system may be 3:1. A ratio of the spherical surface to the aspherical surface among the first to eighth surfaces S1, S2, S3, S4, S5, S6, S7, and S8 of the lenses on the optical axis may be 1:3. The image sensor 190, the optical filter 192, and the cover glass 191 will be referred to the description of the first embodiment. The vehicle or driver's camera module according to the second embodiment of the invention may include or remove a driving member (not shown) around the optical system. That is, since the optical system is disposed in the vehicle, it is difficult to control the focus by moving the lens barrel supporting the optical system in an optical axis direction or/and a direction perpendicular to the optical axis direction with the driving member, so the driving member may be removed. The driving member may be an actuator or a piezoelectric element for an auto focus (AF) function or/and an optical image stabilizer (OIS) function. Here, the lens barrel supporting the optical system may include a plastic material.

In the optical system according to the second embodiment of the invention, the angle of view (diagonal line) may be 70 degrees or less, for example, in the range of 55 degrees to 70 degrees. The effective focal length may be 8 mm or less, such as a range of 4 mm to 8 mm or a range of 5 mm to 6 mm. F number of the optical system or camera module may be 2.4 or less, for example, in the range of 1.8 to 2.4 or in the range of 2 to 2.3. The chief ray angle (CRA) may be greater than or equal to 20 degrees, e.g., in the range of 20 degrees to 35 degrees. In the optical system, a distance (TTL) between the image sensor 190 and the vertex of the first lens 121 may be 11 mm or less. In addition, the wavelength of light used in the optical system may be in the range of 870 nm to 1000 nm. When the temperature ranges from low temperature (e.g., −40 degrees) to high temperature (e.g., 85 degrees), the MTF reduction may be 10% or less. In the optical system according to the second embodiment of the invention, the lens barrel or lens holder supporting the lenses is made of a plastic material, and the size of the lenses is increased, so that deterioration of properties due to heat may be suppressed.

Table 3 shows lens data in the optical system of FIG. 14.

TABLE 3

| | | | | | | Abbe | | | |
|---|---|---|---|---|---|---|---|---|---|
| | | | Curvature | Thickness/ | Refractive | number | | Focal | Semi- |
| | Surface | Shape | radius | distance | Index | (Vd) | Diopter | length | aperture |
| Lens 1 | S1 | Asphere | −3.482 | 0.500 | 1.536 | 56.107 | −179.994 | −5.556 | 2.168 |
| | S2 | Asphere | 21.453 | 0.394 | | | | | 1.854 |
| Lens 2 | S3 | Asphere | 5.480 | 1.556 | 1.644 | 19.246 | 187.947 | 5.321 | 1.779 |
| | S4 | Asphere | −8.114 | 0.300 | | | | | 1.733 |
| Stop | | Flat | 1.E+18 | | | | | | |
| Lens 3 | S5 | Sphere | 7.176 | 0.952 | 1.726 | 25.047 | 130.285 | 7.675 | 1.649 |
| | S6 | Sphere | −23.525 | 3.123 | | | | | 1.708 |
| Lens 4 | S7 | Asphere | 8.502 | 1.123 | 1.644 | 19.246 | −67.109 | −14.901 | 1.978 |
| | S8 | Asphere | 4.273 | 0.552 | | | | | 2.515 |
| BPF | Sa | Flat | 1.E+18 | 0.400 | 1.508 | 64.166 | | | |
| | Sb | Flat | 1.E+18 | 1.000 | | | | | |
| Cover | Sc | Flat | 1.E+18 | 0.400 | 1.508 | 64.166 | | | |
| glass | Sd | Flat | 1.E+18 | 0.200 | | | | | |
| CIS | | Flat | 1.E+18 | 0.000 | | | | | |

In Table 3, the refractive indices of the first to fourth lenses 121, 123, 125, and 127 are the refractive indices at 940 nm, and the Abbe numbers Vd of the first to fourth lenses 121, 123, 125, and 127 at d-line (587 nm) may be less than 30, and the Abbe number Vd of the first lens 121 may be 50 or more. When expressed as an absolute value, the first and second lenses may have a larger diopter than the third and fourth lenses. Based on Table 3 above, the values of curvature radius (mm), thickness (mm), center distance (mm) between lenses, refractive index, Abbe number, and focal length (mm) may be expressed as large and small relational expressions through relative comparison. For example, in absolute values, the Abbe number may represent a relational expression in the order of the first lens>the third lens>the second and fourth lenses. Table 4 is the aspherical coefficient of each surface of each lens in the optical system of FIG. 14.

TABLE 4

| | | Aspherical coefficient | | | | | | | | | |
|---|---|---|---|---|---|---|---|---|---|---|---|
| Item | Surface | K | A | B | C | D | E | F | G | H | J |
| Lens 1 | S1 | −0.03293 | 0.02010 | −0.00113 | 0.00003 | 0.00001 | 1.06E−07 | 6.07E−08 | 1.03E−08 | −1.97E−10 | −8.04E−10 |
| | S2 | 17.01072 | −0.00147 | 0.00524 | −0.00126 | 0.00012 | 1.45E−06 | 5.35E−07 | 1.29E−07 | 2.02E−08 | −1.90E−10 |
| Lens 2 | S3 | 0.02864 | −0.02391 | 0.00343 | −0.00130 | 0.00009 | 2.72E−05 | −1.54E−05 | 5.11E−07 | 7.92E−07 | −1.23E−07 |
| | S4 | 0.77639 | −0.00763 | −0.00132 | 0.00022 | −0.00009 | −1.16E−06 | 5.15E−06 | −1.12E−06 | 2.40E−07 | −2.86E−08 |
| Lens 3 | S5 | | | | | | | | | | |
| | S6 | | | | | | | | | | |
| Lens 4 | S7 | −3.73834 | −0.02504 | −0.00359 | 0.00182 | −0.00074 | 5.63E−05 | 3.77E−05 | −5.94E−06 | −2.04E−06 | 4.22E−07 |
| | S8 | −0.43474 | −0.02219 | −0.00195 | 0.00103 | −0.00021 | 5.37E−06 | 3.67E−06 | −1.32E−07 | −7.96E−08 | 7.27E−09 |

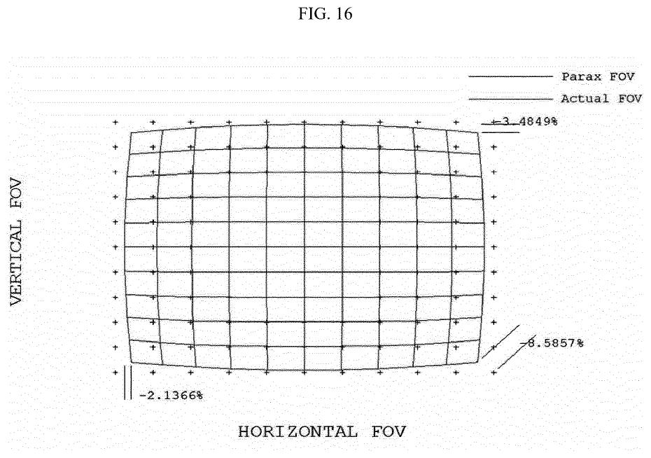

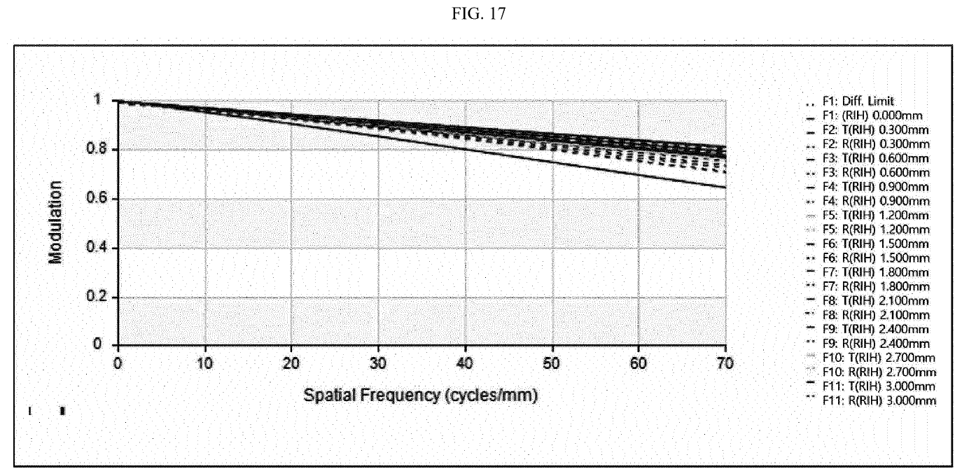

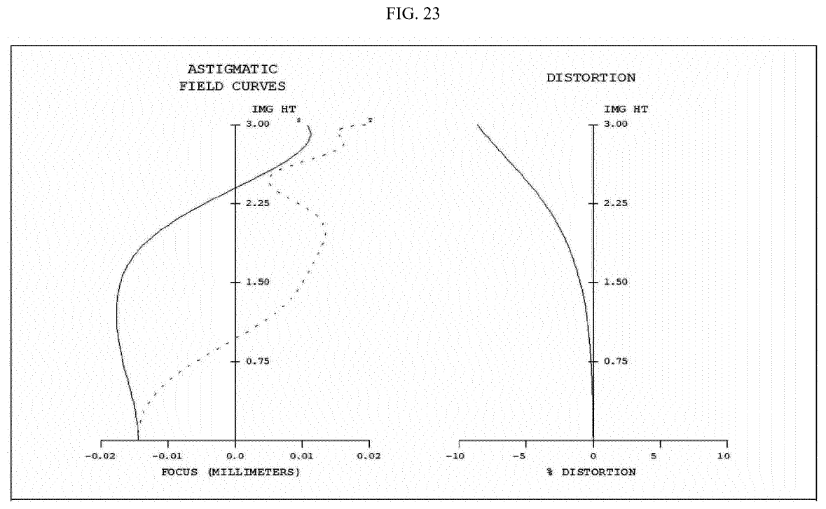

FIG. 15 is a graph showing the ambient light ratio or relative illumination according to the image height in the optical system of FIG. 14, and it may be seen that relative illumination ratio of 55% or more, for example, 70% or more, appears from the center of the image sensor to the diagonal end. FIG. 16 is a diagram showing an actual FOV and a Parax FOV for a horizontal FOV and vertical FOV at room temperature (e.g., 22 degrees) in the optical system of FIG. 14. FIGS. 17 to 19 are graphs showing the diffraction MTF at low temperature, room temperature, and high temperature in the optical system of FIG. 14, and are graphs showing the luminance ratio (modulation) according to the spatial frequency, and FIGS. 20 to 22 are graphs showing diffraction MTF at low temperature, room temperature, and high temperature in the optical system of FIG. 14, and are graphs showing the luminance ratio according to the defocusing position. As shown in FIGS. 17 to 22, it may be seen that at a low temperature of −40 degrees, a room temperature of 22 degrees, and a high temperature of 85 degrees, the decrease in luminance modulation is less than 10% and almost unchanged. As shown in FIGS. 23 to 25, it may be seen that in the optical system of FIG. 14, astigmatic field curves and distortion at low temperature, room temperature, and high temperature are #11 or less (1.0 filed). That is, as shown in FIGS. 17 to 25, it may be seen that the change in optical characteristic data according to the temperature change from low temperature to high temperature is not large, less than 10%.

### Third Embodiment

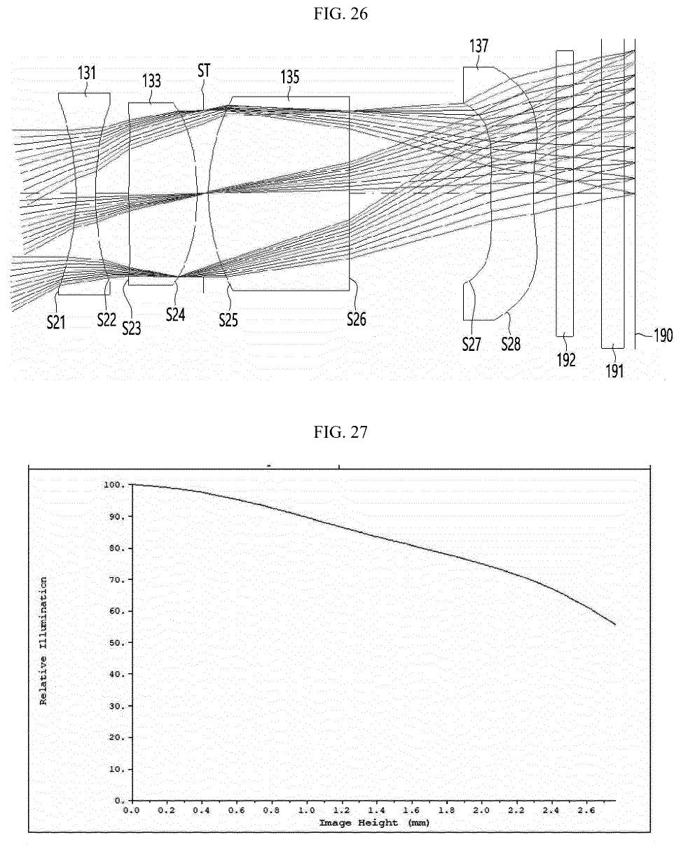

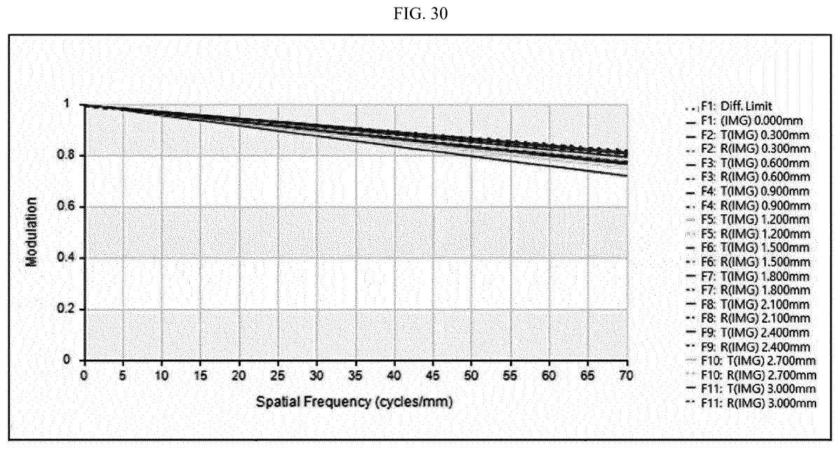

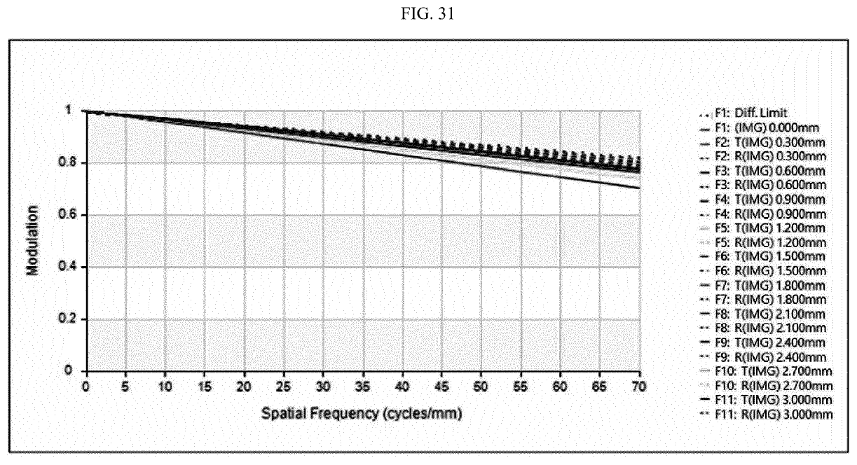

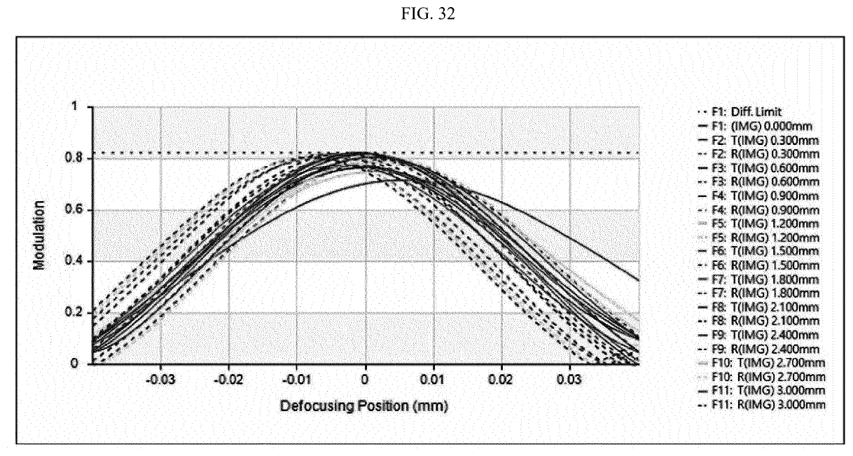

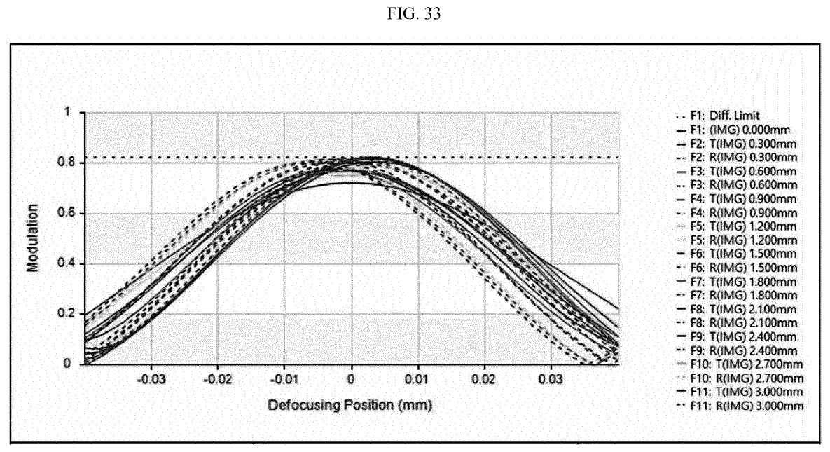

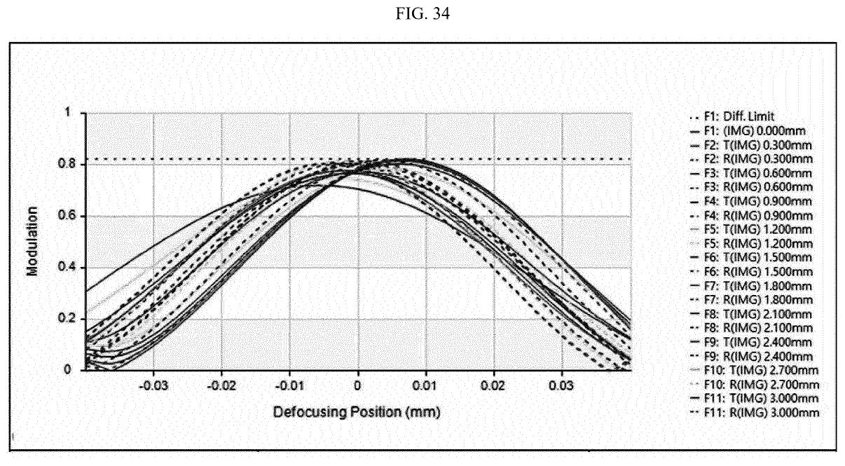

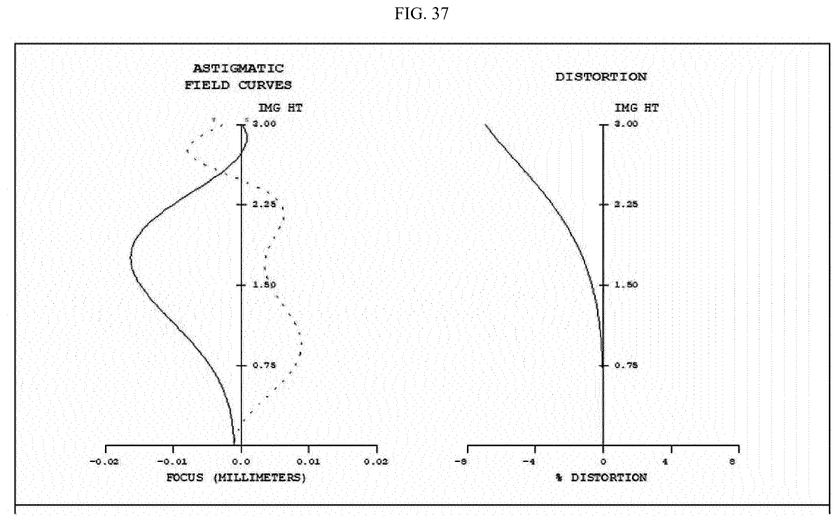

Referring to FIGS. 26 to 37 for the third embodiment. FIG. 32 is a side cross-sectional view showing an optical system for a vehicle according to a third embodiment of the invention, and in describing the third embodiment, the same configuration as the first and second embodiments will be referred to the description of the first and second embodiments.

Referring to FIG. 26, the optical system may include a first lens 131, a second lens 133, a third lens 135, and a fourth lens 137 stacked along the optical axis from the object side to the sensor side. The optical system or a camera module having the same may include an image sensor 190, a cover glass 191 and an optical filter 192 between the image sensor 190 and the lenses, and the description of the first embodiment will be referred to.

The optical system may include an aperture stop ST for adjusting the amount of incident light. A lens group disposed on the object side based on the aperture ST may be divided into a first lens group and a lens group disposed on the sensor side based on the aperture ST may be divided into a second lens group. That is, the first lens group may include the first and second lenses 131 and 133, and the second lens group may include the third and fourth lenses 135 and 137. The aperture stop ST is disposed on the outer circumference between the second lens 133 and the third lens 135, or a circumference of the sensor-side surface of the second lens 133 or a circumference of the object-side surface of the third lens 135 may function as an aperture stop. In the optical system according to the third embodiment, a lens barrel or a lens holder may be formed of a metal material, for example, an aluminum material.

The first lens 131 is a lens closest to the subject and may include a plastic material. The first lens 131 includes an object-side first surface S1 and a sensor-side second surface S2, and both the first surface S1 and the second surface S2 may be aspherical surfaces. The first lens 131 may have negative refractive power and a refractive index of 1.6 or less. The first lens 131 may have a refractive index lower than that of the third lens 135. Here, the refractive index may be a refractive index value at a wavelength of 940 nm. The first surface S1 of the first lens 131 may be concave toward the sensor side, and the second surface S2 may be concave toward the object. An outer circumference of the second surface S2 may include a flat effective region. Expressed as an absolute value, the radius of curvature of the first surface S1 may be smaller than the radius of curvature of the second surface S2, and may be 7 mm or less, for example, in the range of 2 mm to 7 mm. When the first lens 131 is exposed to light from the inside or outside of the vehicle in the camera module, discoloration may be inhibited by placing it in a plastic material. A distance between the first lens 131 and the second lens 133 on the optical axis may be greater than a distance between the second lens 133 and the third lens 135 on the optical axis. The distance between the first lens 131 and the second lens 133 may be greater than a center thickness of the first lens 131. The center thickness of the first lens 131 may be thinner than the center thickness of the second lens 133, for example, 0.6 mm or less or may be in the range of 0.2 mm to 0.6 mm. The center thickness of the first lens 131 may be the smallest among the center thicknesses of the lenses of the optical system. The Abbe number Vd of the first lens 131 may be the smallest among the lenses of the optical system. For example, the Abbe number Vd of the first lens 131 may be less than 30, and may be, for example, in the range of 10 to 29. Expressed as an absolute value, the focal length of the first lens 131 may be smaller than the focal length of the fourth lens 137, and may be 10 mm or less, for example, in the range of 3 mm to 10 mm. An effective diameter through which light is incident from the first lens 131 may be larger than effective diameters of the other second and third lenses 133 and 135. The first lens 131 may be a concave lens.

The second lens 133 may be made of a plastic material. The second lens 133 has a positive (+) refractive power and may be formed of a material having a refractive index of 1.6 or more or a refractive index in the range of 1.6 to 1.7. The second lens 133 may be disposed between the first lens 131 and the third lens 135. The second lens 133 includes an object-side third surface S3 and a sensor-side fourth surface S4, and both of the third surface S3 and the fourth surface S4 may be aspherical surfaces. The third surface S3 may be convex toward the object, and the fourth surface S4 may be convex toward the sensor side. Expressed as an absolute value, the radius of curvature of the third surface S3 may be greater than the radius of curvature of the fourth surface S4, for example, 15 mm or more. When expressed as an absolute value, the radius of curvature of the third surface S3 may be greater than the sum of the radii of curvature of the first, second, and fourth surfaces S1, S2, and S4 and smaller than the radius of curvature of the sixth surface S6. The distance between the second lens 133 and the third lens 135 on the optical axis may be less than 1 mm. The center thickness of the second lens 133 may be 4 or 5 times the distance between the second and third lenses 133 and 135, and may be 1 mm or more or in a range of 1 mm to 1.5 mm. The Abbe number Vd of the second lens 133 may be less than 30, for example, in the range of 10 to 29. The focal length of the second lens 133 may be 10 mm or less. The second lens 133 may be a convex lens. The first and second lenses 131 and 133 are disposed of a plastic material on the object side to inhibit a decrease in the amount of light incident through the object side and to improve aberration of incident light.

The third lens 135 may be made of glass. The third lens 135 has positive (+) refractive power and may be formed with a refractive index of 1.65 or more or a refractive index in the range of 1.65 to 1.8. The refractive index of the third lens 135 may be the highest in the optical system. The third lens 135 may be disposed between the second and fourth lenses 133 and 137. The third lens 135 includes a fifth surface S5 on the object side and a sixth surface S6 on the sensor side, and both of the fifth surface S5 and the sixth surface S6 may be spherical surfaces. The fifth surface S5 may be convex toward the object, and the sixth surface S6 may be convex. Expressed as an absolute value, the radius of curvature of the fifth surface S5 may be smaller than the radius of curvature of the sixth surface S6, and their difference may be 10 mm or more. The distance between the third lens 135 and the fourth lens 137 on the optical axis may be greater than the distance between the second and third lenses 133 and 135 on the optical axis. The distance between the third lens 135 and the fourth lens 137 may be the same as the center thickness of the third lens 135 or may have a difference of 0.5 mm or less. The center thickness of the third lens 135 may be 2 mm or more, for example, in the range of 2 mm to 3 mm. The center thickness of the third lens 135 may be the thickest among the center thicknesses of the lenses of the optical system. The Abbe number Vd of the third lens 135 may be greater than the Abbe number of the fourth lens 137, and may be less than 30, for example, in the range of 10 to 29. Expressed as an absolute value, the focal length of the third lens 135 may be greater than that of the first lens 131 and may be 10 mm or less. The third lens 135 may be a convex lens. Here, the aperture stop ST may be disposed on the circumference between the second lens 133 and the third lens 135, and may be disposed on the circumference between the plastic lens and the glass lens.

The fourth lens 137 is a lens closest to the image sensor 190 and may be made of a plastic material. The fourth lens 137 has negative (−) refractive power and may be formed with a refractive index of 1.7 or less or a refractive index in the range of 1.6 to 1.7. The fourth lens 137 may be disposed between the third lens 135 and the image sensor 190. The fourth lens 137 includes an object-side seventh surface S7 and a sensor-side eighth surface S8, and both the seventh surface S7 and the eighth surface S8 may be aspheric surfaces. The seventh surface S7 may be convex toward the object, and the eighth surface S8 may be concave. The radius of curvature of the seventh surface S7 may be greater than the radius of curvature of the eighth surface S8 and may be smaller than the radius of curvature of the third surface S3, for example, greater than or equal to 15 mm or in the range of 15 mm to 25 mm. The center thickness of the fourth lens 137 may be thinner than the center thickness of the third lens 135, and may be in the range of 1.2 mm or less, for example, 0.5 mm to 1.2 mm, and the Abbe number Vd of the fourth lens 137 may be the same as the Abbe number of the second lens 133, and may be less than 30, for example, in the range of 10 to 29. When the focal length of the fourth lens 137 is obtained as an absolute value, it may be 20 mm or less, for example, in the range of 10 mm to 20 mm.

Each of the lenses 131, 133, 135, and 137 may include an effective region having an effective diameter through which light is incident and a flange portion outside the effective region, which is a non-effective region. The non-effective region may be a region in which light is blocked by a spacer or a light blocking film. Here, the ratio of the lenses disposed on the sensor side and the lenses disposed on the object side with respect to the aperture ST may be 1:1. The ratio of the lens made of plastic to the lens made of glass in the optical system may be 3:1.

The image sensor 190, the optical filter 192, and the cover glass 191 will be referred to the description of the first embodiment. The vehicle camera module according to the third embodiment of the invention may include or remove a driving member (not shown) around the optical system. That is, since the optical system is disposed in the vehicle, it is difficult to control the focus by moving the lens barrel supporting the optical system in an optical axis direction or/and a direction perpendicular to the optical axis direction with the driving member, so the driving member may be removed. The driving member may be an actuator or a piezoelectric element for an auto focus (AF) function or/and an optical image stabilizer (OIS) function. Here, the lens barrel supporting the optical system may include a metal material, for example, an aluminum material.

In the optical system according to the third embodiment of the invention, the angle of view (diagonal line) may be 70 degrees or less, for example, in the range of 55 degrees to 70 degrees. The effective focal length may be 8 mm or less, such as a range of 4 mm to 8 mm or a range of 5 mm to 6 mm. F number of the optical system or camera module may be 2.4 or less, for example, in the range of 1.8 to 2.4 or in the range of 2 to 2.3. The chief ray angle (CRA) may be greater than or equal to 20 degrees, for example, in the range of 20 degrees to 35 degrees. In the optical system, a distance (TTL) between the image sensor 190 and the vertex of the first lens 131 may be 11 mm or less. In addition, the wavelength of light used in the optical system may be in the range of 870 nm to 1000 nm. When the temperature ranges from low temperature (e.g., −40 degrees) to high temperature (e.g., 85 degrees), the MTF reduction may be 10% or less. In the optical system according to the third embodiment of the invention, since the material of the lens barrel or the lens holder supporting the lenses is a metal material, for example, aluminum having high heat dissipation properties, the heat dissipation properties of the lenses may be improved. Accordingly, the proportion of lenses made of plastic in the optical system may be higher than that of lenses made of glass.

Table 5 shows lens data in the optical system of FIG. 26.

TABLE 5

| | | | | | | Abbe | | | |
|---|---|---|---|---|---|---|---|---|---|
| | | | Curvature | Thickness/ | Refractive | number | | Focal | Semi- |
| | Surface | Shape | radius | distance | Index | (Vd) | Diopter | length | aperture |
| Lens 1 | S1 | Asphere | −5.561 | 0.350 | 1.644 | 19.246 | −210.804 | −4.744 | 1.774 |
| | S2 | Asphere | 6.937 | 0.582 | | | | | 1.622 |
| Lens 2 | S3 | Asphere | 22.109 | 1.219 | 1.644 | 19.246 | 167.337 | 5.976 | 1.589 |
| | S4 | Asphere | −4.556 | 0.200 | | | | | 1.600 |
| Stop | | Flat | 1.E+18 | | | | | | |
| Lens 3 | S5 | Sphere | 4.313 | 2.500 | 1.726 | 25.047 | 169.886 | 5.886 | 1.700 |
| | S6 | Sphere | −348.099 | 2.500 | | | | | 1.600 |
| Lens 4 | S7 | Asphere | 18.850 | 0.742 | 1.644 | 19.246 | −77.958 | −12.958 | 1.753 |
| | S8 | Asphere | 5.693 | 0.406 | | | | | 2.218 |
| BPF | Sa | Flat | 1.E+18 | 0.400 | 1.508 | 64.166 | | | |
| | Sb | Flat | 1.E+18 | 1.000 | | | | | |
| Cover | Sc | Flat | 1.E+18 | 0.400 | 1.508 | 64.166 | | | |
| glass | Sd | Flat | 1.E+18 | 0.200 | | | | | |
| CIS | | Flat | 1.E+18 | 0.000 | | | | | |

In Table 5, the refractive indices of the first to fourth lenses 131, 133, 135, and 137 are refractive indices at 940 nm, and the Abbe numbers Vd of the first to fourth lenses 131, 133, 135, and 137 at d-line (587 nm) may be less than 30. When expressed as an absolute value, the first lens may have a larger diopter than that of the other lenses. Based on Table 5 above, the values of radius (mm), thickness (mm), center distance (mm) between lenses, refractive index, Abbe number, and focal length (mm) may be expressed as large and small relational expressions through relative comparison. For example, the focal length in absolute values may represent a relational expression in the order of the fourth lens>second lens>third lens>first lens. Table 6 is the aspheric coefficient of each surface of each lens in the optical system of FIG. 26.

TABLE 6

| | | Aspherical coefficient | | | | | | | | | |
|---|---|---|---|---|---|---|---|---|---|---|---|
| Item | Surface | K | A | B | C | D | E | F | G | H | J |
| Lens 1 | S1 | −5.82684 | −0.00427 | 0.00052 | −0.00025 | 0.00003 | 2.74E−05 | 1.76E−06 | −1.72E−06 | −6.94E−07 | 1.83E−07 |
| | S2 | 14.96729 | −0.00022 | −0.00109 | −0.00083 | 0.00012 | −3.39E−05 | 1.05E−05 | 1.95E−06 | 8.58E−07 | −1.30E−06 |
| Lens 2 | S3 | 99.00000 | −0.00439 | −0.00077 | −0.00084 | −0.00010 | 7.88E−05 | 1.09E−05 | −6.27E−06 | −3.60E−06 | 9.27E−07 |
| | S4 | 2.45988 | −0.00045 | −0.00046 | −0.00010 | −0.00007 | 2.43E−05 | −3.73E−06 | 6.12E−07 | −3.67E−07 | 5.24E−08 |
| Lens 3 | S5 | | | | | | | | | | |
| | S6 | | | | | | | | | | |
| Lens 4 | S7 | −99.00000 | −0.04011 | −0.00447 | −0.00030 | 0.00031 | −1.10E−04 | −1.93E−05 | −1.02E−06 | 7.71E−07 | 1.38E−07 |
| | S8 | 0.33792 | −0.03339 | −0.00222 | 0.00089 | −0.00009 | −1.13E−05 | 6.03E−07 | 2.75E−07 | 2.50E−08 | −6.09E−09 |

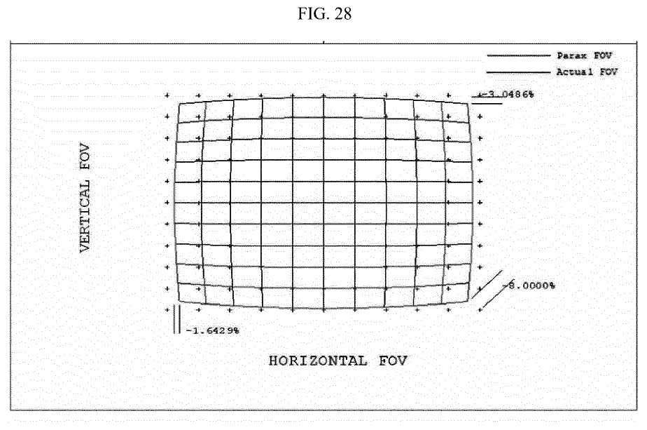

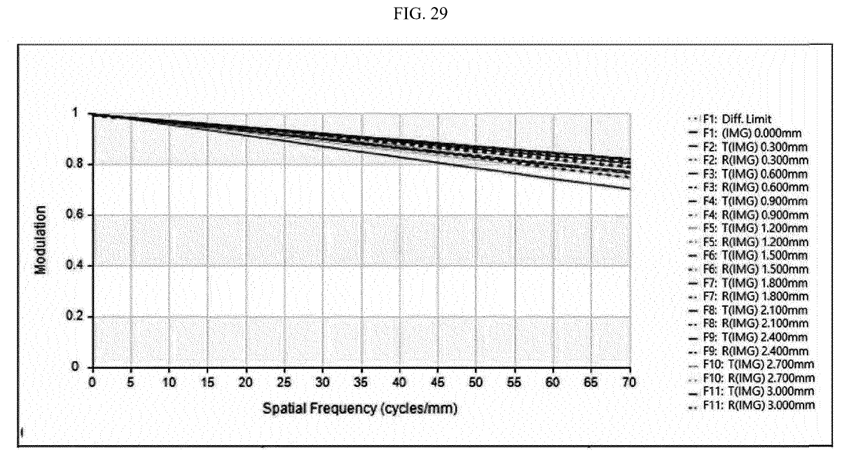

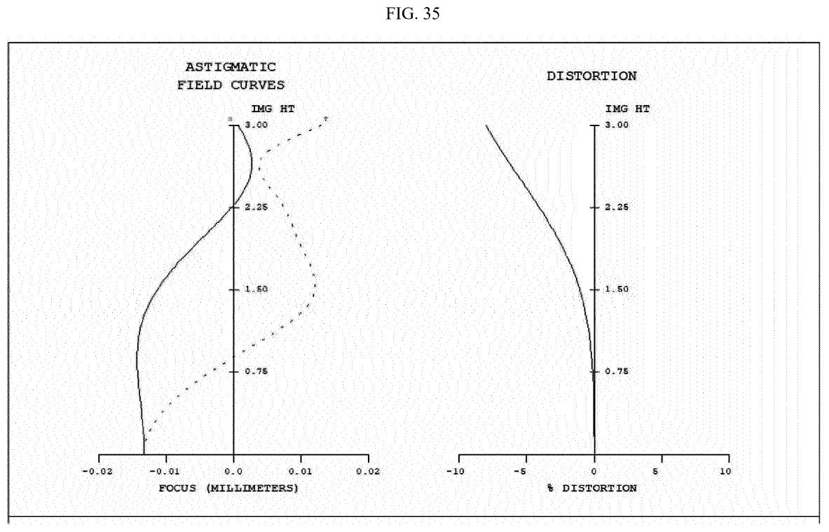

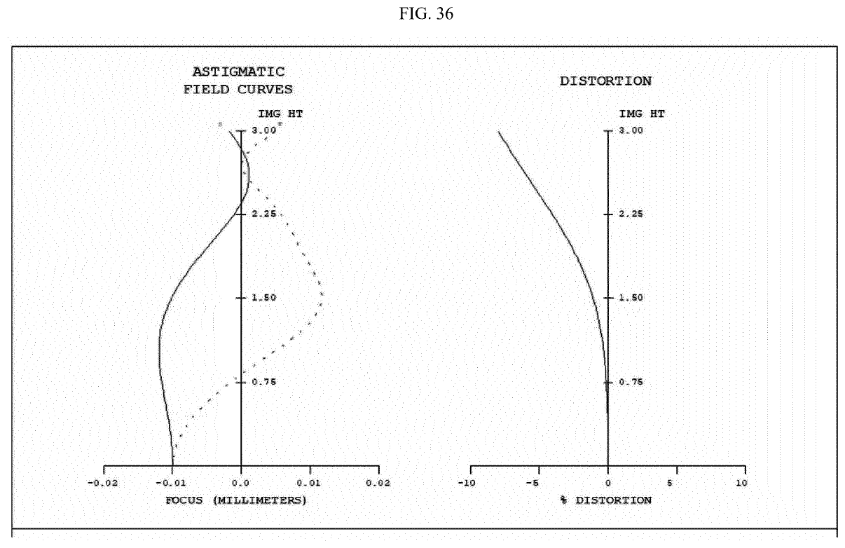

FIG. 27 is a graph showing the ambient light ratio or relative illumination according to the image height in the optical system of FIG. 26, and it may be seen that relative illumination ratio of 55% or more, for example, 70% or more, appears from the center of the image sensor to the diagonal end. FIG. 28 is a diagram showing actual FOV and Parax FOV for horizontal FOV (Field of View) and vertical FOV at room temperature (e.g., 22 degrees) in the optical system of FIG. 26. FIGS. 29 to 31 are graphs showing the diffraction MTF at low temperature, room temperature, and high temperature in the optical system of FIG. 26, and are graphs showing the luminance ratio (modulation) according to the spatial frequency, and FIGS. 32 to 34 are graphs showing the diffraction MTF at low temperature, room temperature, and high temperature in the optical system of FIG. 26, and are graphs showing the luminance ratio according to the defocusing position. As shown in FIGS. 29 to 34, it may be seen that the change in the luminance modulation is less than 10% and hardly changes at a low temperature of −40 degrees, a room temperature of 22 degrees, and a high temperature of 85 degrees. As shown in FIGS. 35 to 38, it may be seen that in the optical system of FIG. 26, astigmatic field curves and distortion at low temperature, room temperature, and high temperature are +11 or less (1.0 filed). That is, as shown in FIGS. 29 to 34, it may be seen that the change in optical characteristic data according to the temperature change from low temperature to high temperature is not large, less than 10%.

### Fourth Embodiment

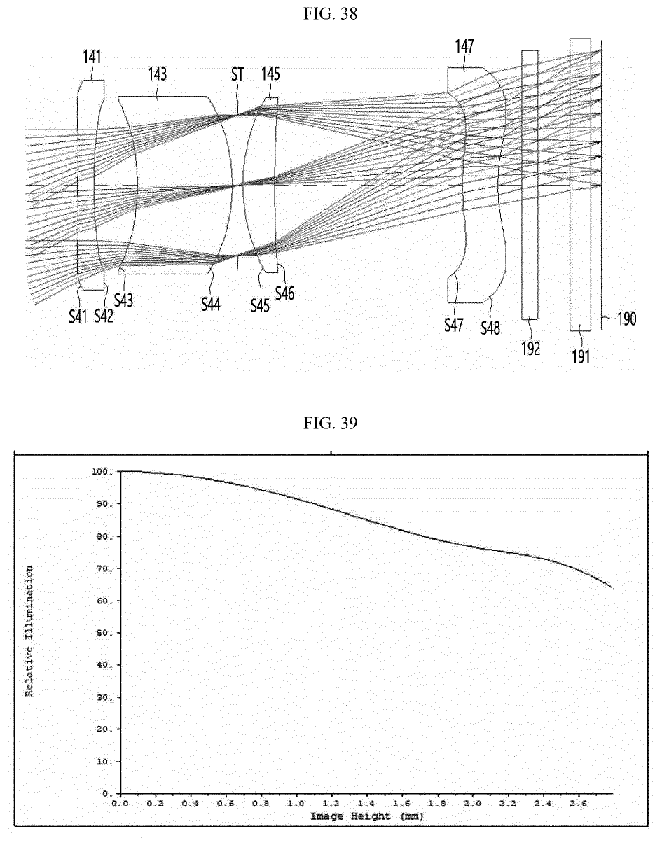

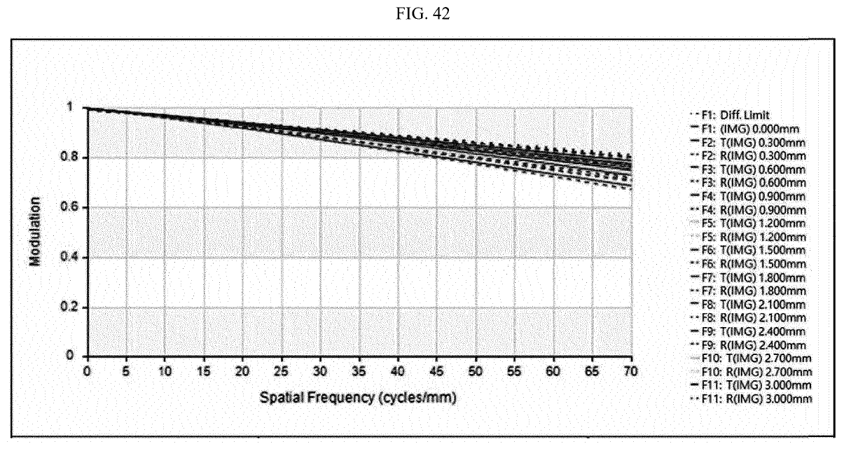

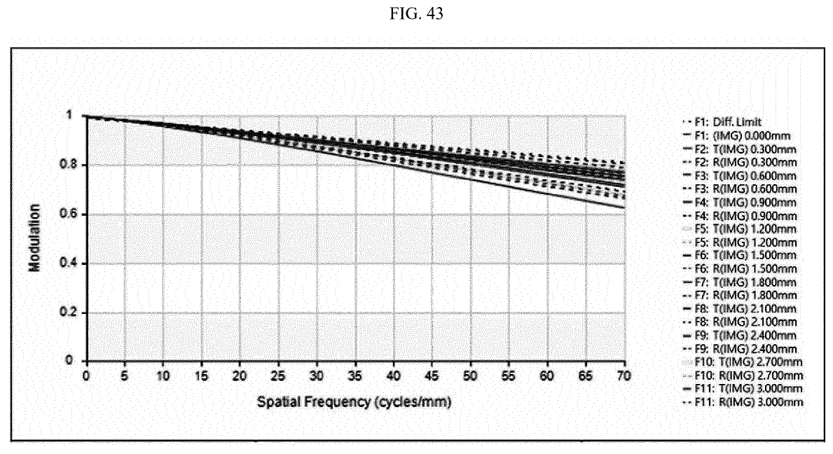

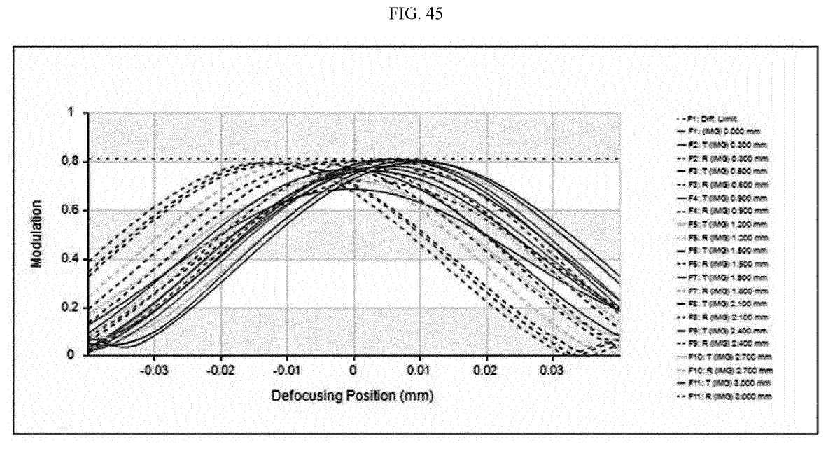

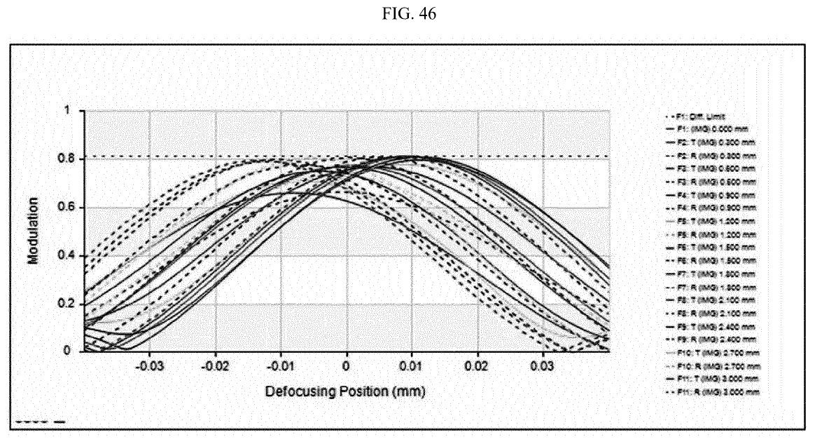

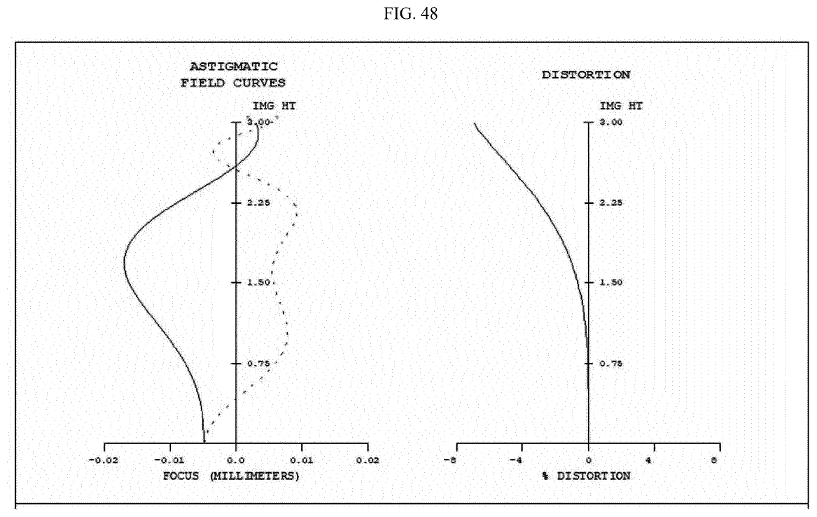

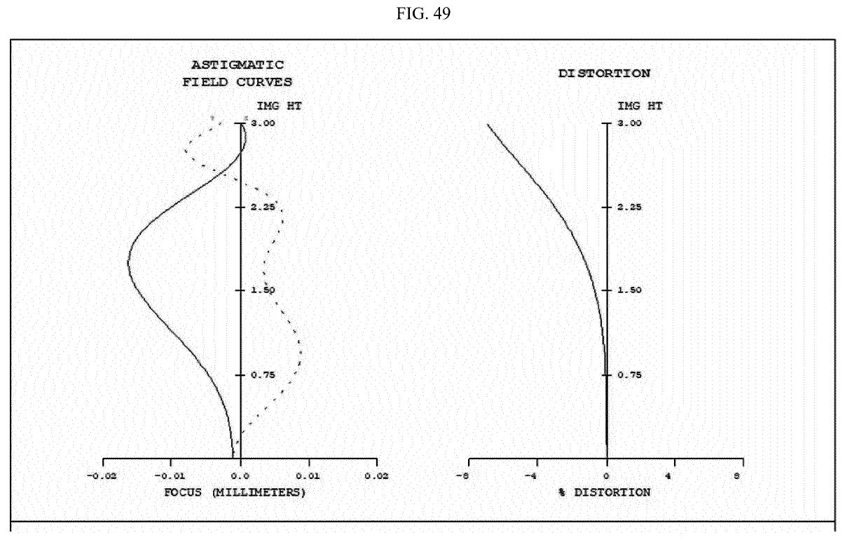

Referring to FIGS. 38 to 49 for the fourth embodiment. FIG. 38 is a side cross-sectional view showing an optical system for a vehicle according to a fourth embodiment of the invention. In the description of the fourth embodiment, the same configuration as the first to third embodiments will be referred to the description of the first to third embodiments.

Referring to FIG. 38, the optical system may include a first lens 141, a second lens 143, a third lens 145, and a fourth lens 147 stacked along the optical axis from the object side to the sensor side. The optical system or a camera module having the same may include an image sensor 190, and a cover glass 191 and an optical filter 192 between the image sensor 190 and the lenses. The optical system may include an aperture stop (ST) for adjusting the amount of incident light. A lens group disposed on the object side based on the aperture stop ST may be divided into a first lens group and a lens group disposed on the sensor side based on the aperture stop ST may be divided into a second lens group. That is, the first lens group may include the first and second lenses 141 and 143, and the second lens group may include the third and fourth lenses 145 and 147. The aperture stop ST is disposed on the outer circumference between the second lens 143 and the third lens 145, the circumference of the sensor-side surface of the second lens 143, or a circumference of the object-side surface of the third lens 145 may function as an aperture stop. In the optical system according to the fourth embodiment, a lens barrel or a lens holder may be made of a plastic material.

The first lens 141 is a lens closest to the subject and may include a plastic material. The first lens 141 includes an object-side first surface S1 and a sensor-side second surface S2, and both the first surface S1 and the second surface S2 may be aspherical surfaces. The first lens 141 may have negative refractive power and a refractive index of 1.6 or more. The first lens 141 may have a refractive index lower than that of the third lens 145. Here, the refractive index may be a refractive index value at a wavelength of 940 nm. The first surface S1 of the first lens 141 may be concave toward the sensor side, and the second surface S2 may be concave toward the object. An outer circumference of the second surface S2 may include a flat effective region. Expressed as an absolute value, the radius of curvature of the first surface S1 may be greater than the radius of curvature of the second surface S2, and may be in the range of 40 mm or more, for example, 40 mm to 60 mm. The radius of curvature of the first surface S1 may be the largest among the object-side surface and the sensor-side surface of the lenses of the optical system. When the first lens 141 is exposed to light from the inside or outside of the vehicle in the camera module, discoloration may be inhibited by placing it in a plastic material. The distance between the first lens 141 and the second lens 143 on the optical axis may be greater than the distance between the second lens 143 and the third lens 145 on the optical axis, for example, twice or more. The distance between the first lens 141 and the second lens 143 may be greater than a center thickness of the first lens 141. The center thickness of the first lens 141 may be thinner than the center thickness of the second lens 143, for example, 0.5 mm or less, or may be in the range of 0.2 mm to 0.5 mm. The Abbe number Vd of the first lens 141 may be less than 30, for example, in the range of 10 to 29. The Abbe number Vd of the first lens 141 may be smaller than the Abbe number of the third lens 145. Expressed as an absolute value, the focal length of the first lens 141 may be greater than the focal length of the fourth lens 147, and may be 10 mm or more, for example, in the range of 10 mm to 20 mm. An effective diameter through which light is incident from the first lens 141 may be larger than the effective diameters of the other second and third lenses 143 and 145. The first lens 141 may be a concave lens.

The second lens 143 may be made of a plastic material. The second lens 143 has a positive (+) refractive power and may be formed of a material having a refractive index of 1.6 or greater or a refractive index in the range of 1.6 to 1.7. The second lens 143 may be disposed between the first lens 141 and the third lens 145. The second lens 143 includes an object-side third surface S3 and a sensor-side fourth surface S4, and both of the third surface S3 and the fourth surface S4 may be aspherical surfaces. The third surface S3 may be convex toward the object, and the fourth surface S4 may be concave toward the sensor side. Expressed as an absolute value, the radius of curvature of the third surface S3 may be greater than the radius of curvature of the fourth surface S4, for example, and may have a difference of 3 mm or less from the radius of curvature of the fourth surface S4. When expressed as an absolute value, the difference between the radius of curvature of the fourth surface S4 and the radius of curvature of the fifth surface S5 may be 5 mm or less. The distance between the second lens 143 and the third lens 145 on the optical axis may be 1 mm or more. The center thickness of the second lens 143 may be greater than the center distance between the second and third lenses 143 and 145 and may be the largest in the optical lenses. The center thickness of the second lens 143 may be greater than or equal to 1.2 mm or may range from 1.2 mm to 2.2 mm. The Abbe number Vd of the second lens 143 may be less than 30, for example, in the range of 10 to 29. The focal length of the second lens 143 may be greater than or equal to 10 mm. The second lens 143 may be a convex lens. The first and second lenses 141 and 143 are disposed of a plastic material on the object side to inhibit a decrease in the amount of light incident through the object side and to improve aberration of incident light.

The third lens 145 may be made of glass. The third lens 145 has positive (+) refractive power and may be formed with a refractive index of 1.65 or more or a refractive index in the range of 1.65 to 1.8. The refractive index of the third lens 145 may be the highest in the optical system. The third lens 145 may be disposed between the second and fourth lenses 143 and 147. The third lens 145 includes a fifth surface S5 on the object side and a sixth surface S6 on the sensor side, and both of the fifth surface S5 and the sixth surface S6 may be spherical surfaces. The fifth surface S5 may be convex toward the object, and the sixth surface S6 may be concave. Expressed as an absolute value, the radius of curvature of the fifth surface S5 may be smaller than the radius of curvature of the sixth surface S6, and the difference may be 10 mm or more. The distance between the third lens 145 and the fourth lens 147 on the optical axis may be larger than the distance between the second and third lenses 143 and 145. The distance between the third lens 145 and the fourth lens 147 may be greater than the center thickness of the third lens 145, for example, four times or more than the center thickness of the third lens 145. The center thickness of the third lens 145 may be 1 mm or less, for example, in the range of 0.2 mm to 1 mm. The Abbe number Vd of the third lens 145 may be greater than the Abbe numbers of the first, third, and fourth lenses 131, 133, and 147, and may be less than 30, for example, in the range of 20 to 29. Expressed as an absolute value, the focal length of the third lens 145 may be smaller than that of the first and second lenses 141 and 143 and may be 10 mm or less. The third lens 145 may be a convex lens. The Abbe number of the third lens 145 may be the largest among lenses in the optical system. Here, the aperture stop ST may be disposed on the circumference between the second lens 143 and the third lens 145, and may be disposed on the circumference between the plastic lens and the glass lens.

The fourth lens 147 is a lens closest to the image sensor 190 and may be made of a plastic material. The fourth lens 147 has negative (−) refractive power and may be formed with a refractive index of 1.7 or less or a refractive index in the range of 1.6 to 1.7. The fourth lens 147 may be disposed between the third lens 145 and the image sensor 190. The fourth lens 147 includes an object-side seventh surface S7 and a sensor-side eighth surface S8, and both the seventh surface S7 and the eighth surface S8 may be aspherical surfaces. The seventh surface S7 may be convex toward the object, and the eighth surface S8 may be concave. The radius of curvature of the seventh surface S7 may be larger than the radius of curvature of the eighth surface S8 and may be smaller than the radius of curvature of the second surface S2, for example, 10 mm or less or may be in the range of 2 mm to 10 mm. The center thickness of the fourth lens 147 may be thicker than the center thickness of the third lens 145, and may be 1 mm or less, for example, in the range of 0.3 mm to 1 mm, and the Abbe number Vd of the fourth lens 147 may be the same as the Abbe number of the second lens 143, and may be less than 30, for example, in the range of 10 to 29. When the focal length of the fourth lens 147 is obtained as an absolute value, it may be 20 mm or more, for example, in the range of 20 mm to 30 mm. When the focal length of the fourth lens 147 is obtained as an absolute value, it may be the largest among lenses in the optical system.

Each of the lenses 141, 143, 145, and 147 may include an effective region having an effective diameter through which light is incident, and a flange portion outside the effective region, which is a non-effective region. The non-effective region may be a region in which light is blocked by a spacer or a light blocking film. Here, the ratio of the lens disposed on the sensor side and the lens disposed on the object side based on the aperture stop ST may be 1:1, and the ratio of the lens made of plastic to the lens made of glass in the optical system may be 3:1.

The image sensor 190, the optical filter 192, and the cover glass 191 will be referred to the description of the first embodiment. In the camera module for a vehicle or driver according to the fourth embodiment of the invention, the angle of view (diagonal line) in the optical system may be 70 degrees or less, for example, in the range of 55 degrees to 70 degrees. The effective focal length may be 8 mm or less, such as a range of 4 mm to 8 mm or a range of 5 mm to 6 mm. F number of the optical system or camera module may be 2.4 or less, for example, in the range of 1.8 to 2.4 or in the range of 2 to 2.3. The chief ray angle (CRA) may be greater than or equal to 20 degrees, for example, in the range of 20 degrees to 35 degrees. In the optical system, a distance (TTL) between the image sensor 190 and the vertex of the first lens 141 may be 11 mm or less. In addition, the wavelength of light used in the optical system may be in the range of 870 nm to 1000 nm. When the temperature ranges from low temperature (e.g., −40 degrees) to high temperature (e.g., 85 degrees), the MTF reduction may be 10% or less. In the optical system according to the fourth embodiment of the invention, since the material of the lens barrel or the lens holder supporting the lenses is a metal material, for example, aluminum having high heat dissipation properties, the heat dissipation properties of the lenses may be improved. Accordingly, the proportion of lenses made of plastic in the optical system may be higher than that of lenses made of glass.

Table 7 shows lens data in the optical system of FIG. 38.

TABLE 7

| | | | | | | Abbe | | | |
|---|---|---|---|---|---|---|---|---|---|
| | | | Curvature | Thickness/ | Refractive | number | | Focal | Semi- |
| | Surface | Shape | radius | distance | Index | (Vd) | Diopter | length | aperture |
| Lens 1 | S1 | Asphere | 53.298 | 0.300 | 1.644 | 19.246 | −60.578 | −16.508 | 2.033 |
| | S2 | Asphere | 8.839 | 0.823 | | | | | 1.784 |
| Lens 2 | S3 | Asphere | −5.303 | 1.794 | 1.644 | 19.246 | 59.217 | 16.887 | 1.695 |
| | S4 | Asphere | −4.036 | 0.200 | | | | | 1.658 |
| Stop | | Flat | | | | | | | |
| Lens 3 | S5 | Sphere | 4.027 | 0.599 | 1.726 | 25.047 | 153.668 | 6.508 | 1.664 |
| | S6 | Sphere | 25.605 | 3.553 | | | | | 1.672 |
| Lens 4 | S7 | Asphere | 5.241 | 0.670 | 1.644 | 19.246 | −42.323 | −23.628 | 1.969 |
| | S8 | Asphere | 3.703 | 0.460 | | | | | 2.422 |
| BPF | Sa | Flat | 1.E+18 | 0.400 | 1.508 | 64.166 | | | |
| | Sb | Flat | 1.E+18 | 1.000 | | | | | |
| | Sc | Flat | 1.E+18 | 0.400 | 1.508 | 64.166 | | | |
| Cover glass | Sd | Flat | 1.E+18 | 0.200 | | | | | |
| CIS | | Flat | 1.E+18 | 0.000 | | | | | |

In Table 7, the refractive indices (Index) of the first to fourth lenses 141, 143, 145, and 147 are the refractive indices at 940 nm, and the Abbe numbers Vd of the first to fourth lenses 141, 143, 145, and 147 at d-line (587 nm) may be less than 30. Based on Table 8 above, the values of radius (mm), thickness (mm), center distance (mm) between lenses, refractive index, Abbe number, and focal length (mm) may be expressed as large and small relational expressions through relative comparison. For example, the diopter obtained as an absolute value may represent a relational expression in the order of the third lens>first lens>second lens>fourth lens. Table 8 is the aspheric coefficient of each surface of each lens in the optical system of FIG. 38.

TABLE 8

| | | Aspherical coefficient | | | | | | | | | |
|---|---|---|---|---|---|---|---|---|---|---|---|
| Item | Surface | K | A | B | C | D | E | F | G | H | J |
| Lens 1 | S1 | −99.00000 | −0.00921 | 0.00149 | 0.00002 | 0.00002 | 4.93E−06 | −8.69E−07 | −8.71E−08 | 4.45E−08 | 7.56E−09 |
| | S2 | 22.93722 | −0.01162 | 0.00114 | −0.00043 | 0.00013 | −2.26E−05 | 1.21E−05 | −3.08E−06 | −9.46E−07 | 3.25E−07 |
| Lens 2 | S3 | 2.79184 | −0.00253 | −0.00076 | −0.00004 | −0.00004 | 4.01E−05 | −4.83E−07 | −2.37E−06 | −5.70E−07 | 5.07E−07 |
| | S4 | 1.89530 | 0.00178 | 0.00006 | 0.00009 | −0.00002 | 2.21E−05 | −8.41E−06 | 7.89E−07 | 4.81E−07 | −9.75E−08 |
| Lens 3 | S5 | | | | | | | | | | |
| | S6 | | | | | | | | | | |
| Lens 4 | S7 | 1.18377 | −0.03243 | −0.00239 | −0.00077 | 0.00025 | −5.14E−05 | −7.14E−07 | −2.23E−07 | −5.29E−08 | 3.42E−09 |
| | S8 | 0.16608 | −0.02555 | −0.00428 | 0.00091 | −0.00004 | −1.31E−05 | −2.88E−07 | 2.63E−07 | 4.33E−08 | −7.62E−09 |

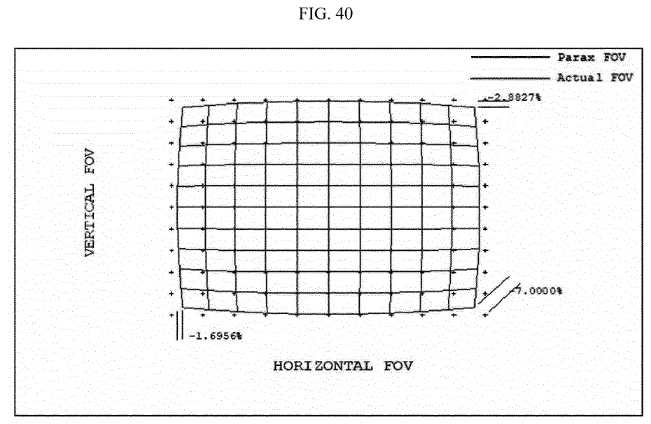

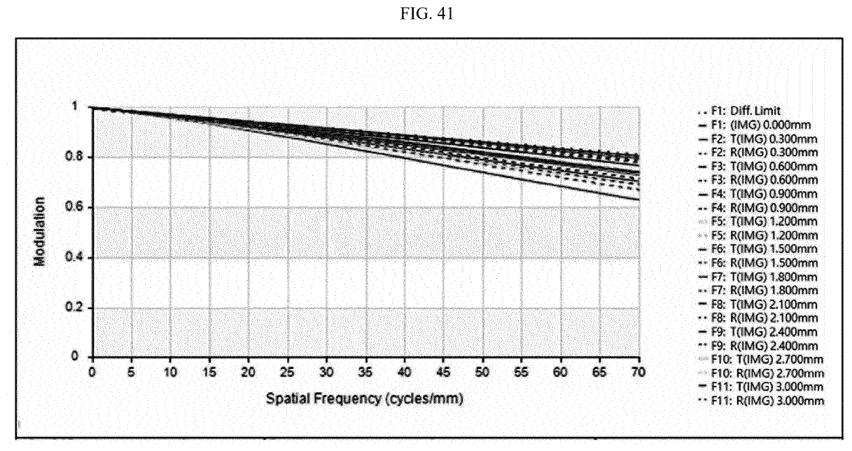

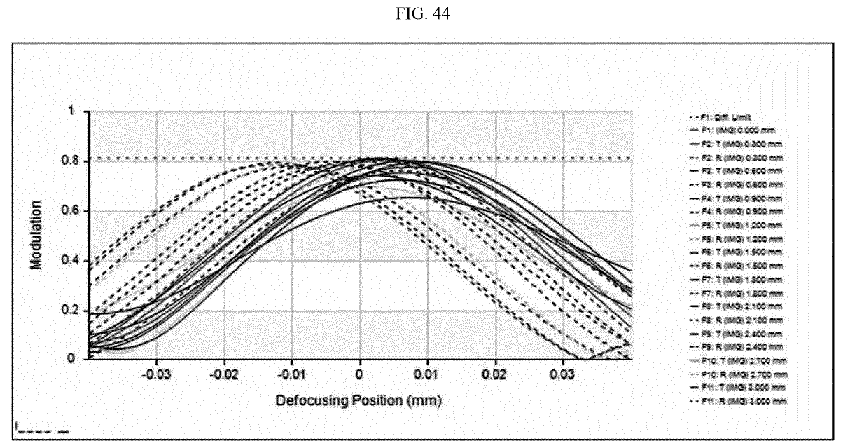

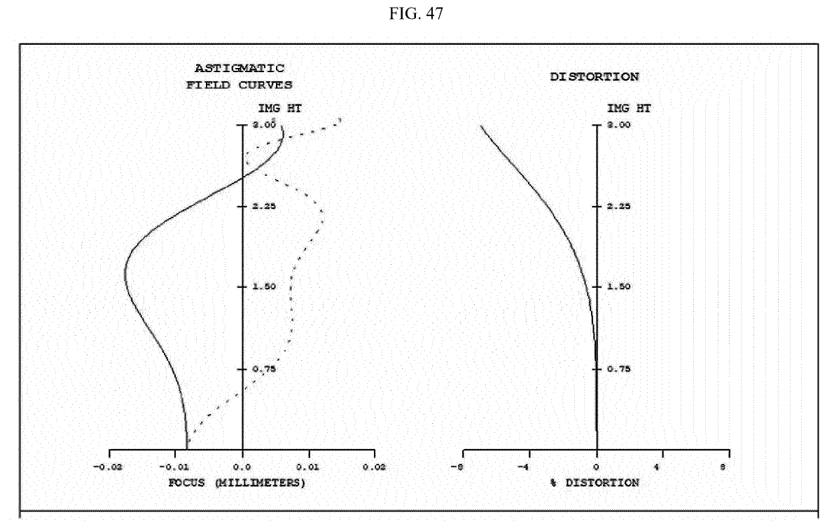

FIG. 39 is a graph showing the ambient light ratio or relative illumination according to the image height in the optical system of FIG. 38, and it may be seen that relative illumination ratio of 55% or more, for example, 70% or more, appears from the center of the image sensor to the diagonal end. FIG. 40 is a diagram showing actual FOV and Parax FOV for horizontal FOV (Field of View) and vertical FOV at room temperature (e.g., 22 degrees) in the optical system of FIG. 38. FIGS. 41 to 43 are graphs showing the diffraction MTF at low temperature, room temperature, and high temperature in the optical system of FIG. 38, and are graphs showing the luminance ratio (modulation) according to the spatial frequency, and FIGS. 44 to 46 are graphs showing diffraction MTF at low temperature, room temperature, and high temperature in the optical system of FIG. 38, and are graphs showing the luminance ratio according to the defocusing position. As shown in FIGS. 41 to 46, it may be seen that the luminance ratio (modulation) is hardly changed at a low temperature of −40 degrees, a room temperature of 22 degrees, and a high temperature of 85 degrees. As shown in FIGS. 47 to 49, it may be seen that in the optical system of FIG. 38, astigmatic field curves and distortion at low temperature, room temperature, and high temperature are +11 or less (1.0 filed). That is, as shown in FIGS. 41 to 49, it may be seen that the change in optical characteristic data according to the temperature change from low temperature to high temperature is not large, less than 10%.

### Fifth Embodiment

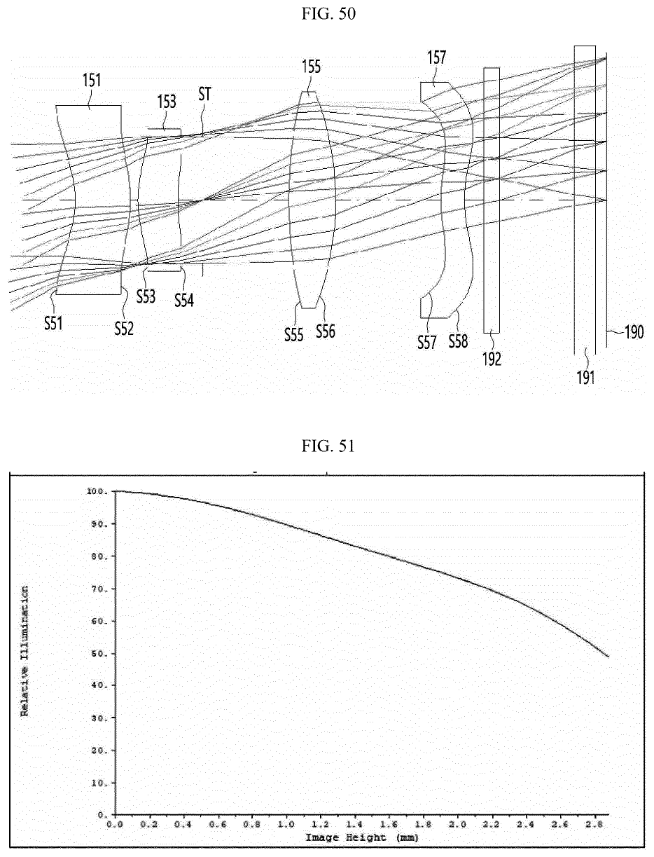

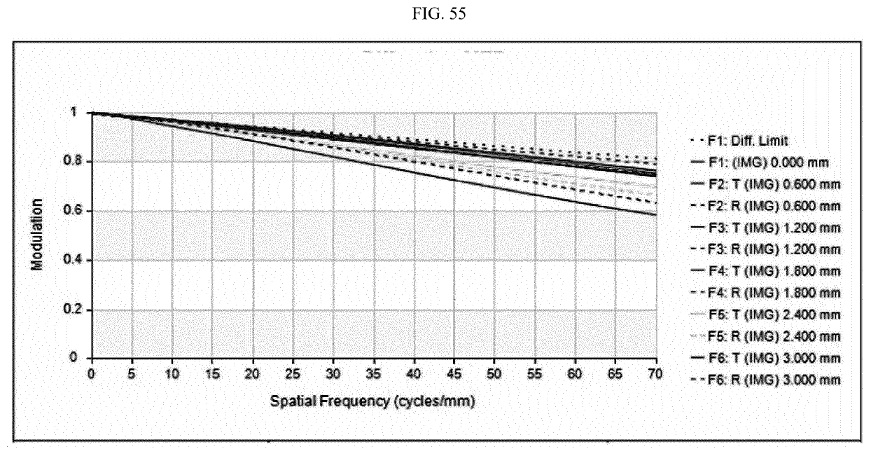

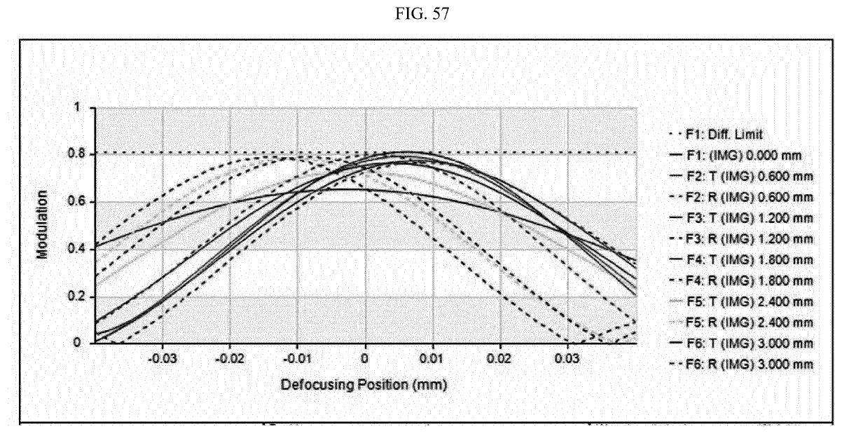

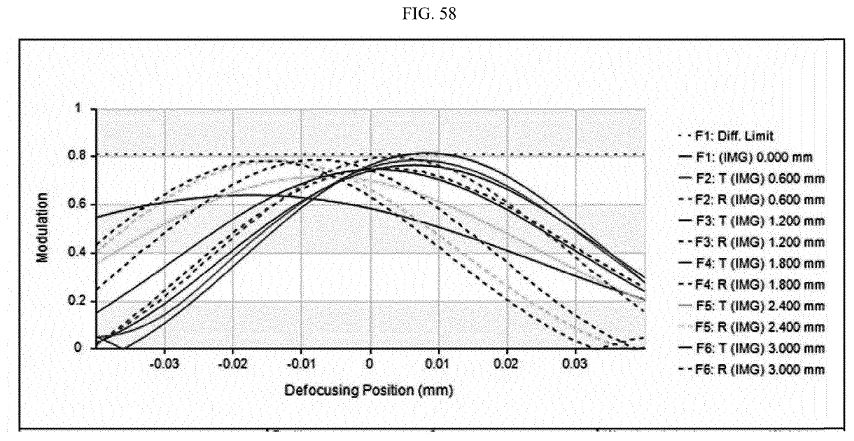

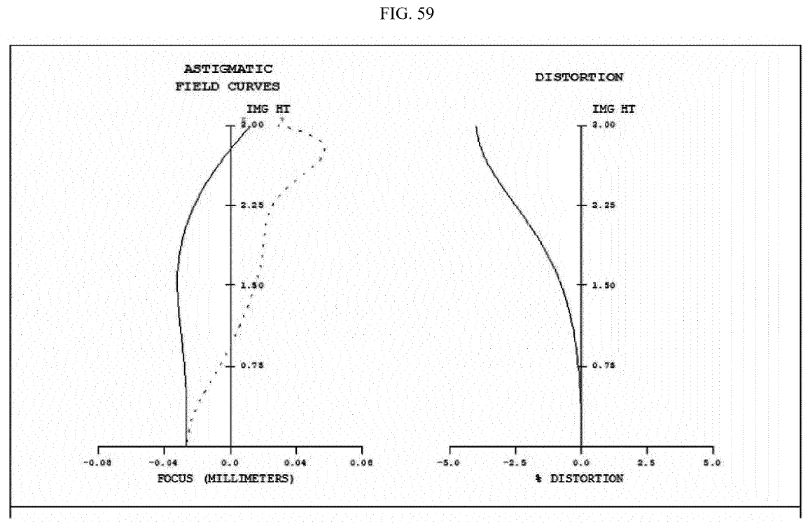

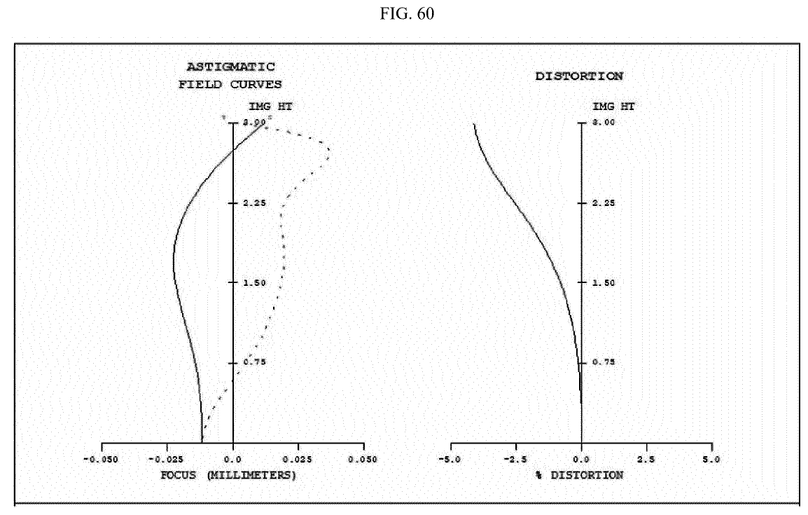

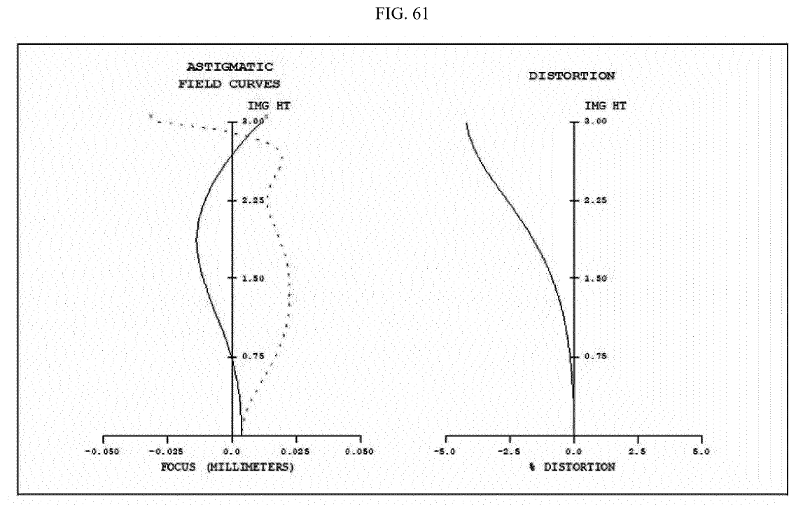

The fifth embodiment will refer to FIGS. 50 to 61. FIG. 50 is a side cross-sectional view showing an optical system for a vehicle according to a fifth embodiment of the invention. In the description of the fifth embodiment, the same configuration as the first to fourth embodiments will be referred to the description of the first to fourth embodiments.

Referring to FIG. 50, the optical system may include a first lens 151, a second lens 152, a third lens 153, and a fourth lens 154 stacked along the optical axis from the object side to the sensor side. The optical system or a camera module having the same may include an image sensor 190, and a cover glass 191 and an optical filter 192 between the image sensor 190 and the lenses. The optical system may include an aperture stop ST for adjusting the amount of incident light. A lens group disposed on the object side based on the aperture ST may be divided into a first lens group and the lens group disposed on the sensor side based on the aperture ST may be divided into a second lens group. That is, the first lens group may include the first and second lenses 151 and 153, and the second lens group may include the third and fourth lenses 155 and 157. The aperture stop ST is disposed on the outer circumference between the second lens 153 and the third lens 155, or a circumference of the sensor-side surface of the second lens 153 or a circumference of the object-side surface of the third lens 155 may function as an aperture stop. In the optical system according to the fifth embodiment, a lens barrel or a lens holder may be formed of a metal material, for example, an aluminum material.

The first lens 151 is a lens closest to the subject and may include a plastic material. The first lens 151 includes an object-side first surface S1 and a sensor-side second surface S2, and both the first surface S1 and the second surface S2 may be aspherical surfaces. The first lens 151 may have negative refractive power and a refractive index of 1.6 or more. The first lens 151 may have a refractive index lower than that of the third lens 155. Here, the refractive index may be a refractive index value at a wavelength of 940 nm. The first surface S1 of the first lens 151 may be concave toward the sensor, and the second surface S2 may be convex toward the object. Expressed as an absolute value, the radius of curvature of the first surface S1 may be smaller than the radius of curvature of the second surface S2, and the difference may be 2 mm or less. The radius of curvature of the first surface S1 may be the smallest among the object-side surface and the sensor-side surface of the lenses of the optical system. When the first lens 151 is exposed to light from the inside or outside of the vehicle in the camera module, discoloration may be inhibited by placing it in a plastic material. A distance between the first lens 151 and the second lens 153 on the optical axis may be smaller than a distance between the second lens 153 and the third lens 155 on the optical axis. A distance between the first lens 151 and the second lens 153 may be smaller than a center thickness of the first lens 151. The center thickness of the first lens 151 may be greater than the center thickness of the second lens 153, and may be, for example, 0.8 mm or more or in a range of 0.8 mm to 1.4 mm. The Abbe number Vd of the first lens 151 may be smaller than the Abbe number of the third lens 155. For example, the Abbe number Vd of the first lens 151 may be less than 30 and may be in the range of 10 to 29. Expressed as an absolute value, the focal length of the first lens 151 may be greater than the focal length of the third lens 155, and may be 10 mm or more, for example, in the range of 10 mm to 22 mm. An effective diameter through which light is incident from the first lens 151 may be larger than an effective diameter of another second lens 153. The first lens 151 may be a concave lens.

The second lens 153 may be made of a plastic material. The second lens 153 has a positive (+) refractive power and may be formed of a material having a refractive index of 1.6 or more or a refractive index in the range of 1.6 to 1.7. The second lens 153 may be disposed between the first lens 151 and the third lens 155. The second lens 153 includes an object-side third surface S3 and a sensor-side fourth surface S4, and both of the third surface S3 and the fourth surface S4 may be aspherical surfaces. The third surface S3 may be convex toward the object, and the fourth surface S4 may be concave. Expressed as an absolute value, the radius of curvature of the third surface S3 may be smaller than the radius of curvature of the fourth surface S4, for example, 5 mm or less. When expressed as an absolute value, the radius of curvature of the fourth surface S4 may be greater than the radius of curvature of the first and second surfaces S1 and S2. A distance between the second lens 153 and the third lens 155 on the optical axis may be 1.5 mm or more. The center thickness of the second lens 153 may be less than 0.5 times the distance between the second and third lenses 153 and 155, may be less than 1.2 mm, or may be in the range of 0.5 mm to 1.2 mm. The Abbe number Vd of the second lens 153 may be the same as that of the first lens 151 and may be less than 30, for example, in the range of 10 to 29. The focal length of the second lens 153 may be greater than or equal to 10 mm. The second lens 153 may be a convex lens. The first and second lenses 151 and 153 are disposed of a plastic material on the object side to inhibit a decrease in the amount of light incident through the object side and to improve aberration of incident light.

The third lens 155 may be made of glass. The third lens 155 has a positive (+) refractive power and may be formed with a refractive index of 1.65 or more or a refractive index in the range of 1.65 to 1.8. The refractive index of the third lens 155 may be the highest in the optical system. The third lens 155 may be disposed between the second and fourth lenses 153 and 157. The third lens 155 includes a fifth surface S5 on the object side and a sixth surface S6 on the sensor side, and both the fifth surface S5 and the sixth surface S6 may be spherical surfaces. The fifth surface S5 may be convex toward the object, and the sixth surface S6 may be convex. Expressed as an absolute value, the radius of curvature of the fifth surface S5 may be greater than the radius of curvature of the sixth surface S6, and the difference may be 10 mm or more. The distance between the third lens 155 and the fourth lens 157 on the optical axis may be larger than the distance between the first and second lenses 151 and 153 on the optical axis. The distance between the third lens 155 and the fourth lens 157 may be larger than the center thickness of the third lens 155, for example, twice or more than the center thickness of the third lens 155. The center thickness of the third lens 155 may be greater than or equal to 1.5 mm, for example, in the range of 1.5 mm to 2.3 mm. The Abbe number Vd of the third lens 155 may be greater than the Abbe number of the fourth lens 157, and may be less than 30, for example, in the range of 20 to 29. Expressed as an absolute value, the focal length of the third lens 155 may be smaller than that of the first and second lenses 151 and 153 and may be 10 mm or less. The third lens 155 may be a convex lens. Here, the aperture stop ST may be disposed on the circumference between the second lens 153 and the third lens 155, and may be disposed on the circumference between the plastic lens and the glass lens.

The fourth lens 157 is a lens closest to the image sensor 190 and may be made of a plastic material. The fourth lens 157 has negative (−) refractive power and may be formed with a refractive index of 1.7 or less or a refractive index in the range of 1.6 to 1.7. The fourth lens 157 may be disposed between the third lens 155 and the image sensor 190. The fourth lens 157 includes an object-side seventh surface S7 and a sensor-side eighth surface S8, and both the seventh surface S7 and the eighth surface S8 may be aspherical surfaces. The seventh surface S7 may be convex toward the object, and the eighth surface S8 may be concave. The radius of curvature of the seventh surface S7 may be larger than the radius of curvature of the eighth surface S8 and may be smaller than the radius of curvature of the second surface S2, and may be, for example, 5 mm or less or in the range of 3 mm to 5 mm. The center thickness of the fourth lens 157 may be smaller than the center thickness of the third lens 155 and may be 1 mm or less, for example, in the range of 0.2 mm to 1 mm, and the Abbe number Vd of the fourth lens 157 may be the same as the Abbe number of the second lens 153, and may be less than 30, for example, in the range of 10 to 29. When the focal length of the fourth lens 157 is obtained as an absolute value, it may be 15 mm or more, for example, in the range of 15 mm to 25 mm, and may be the largest among lenses in the optical system.

Each of the lenses 151, 153, 155, and 157 may include an effective region having an effective diameter through which light is incident and a flange portion outside the effective region, which is a non-effective region. The non-effective region may be a region in which light is blocked by a spacer or a light blocking film. Here, the ratio of the lens disposed on the sensor side and the lens disposed on the object side based on the aperture ST may be 1:1, and the ratio of the lens made of plastic to the lens made of glass in the optical system may be 3:1.

The image sensor 190, the optical filter 192, and the cover glass 191 will be referred to the description of the first embodiment. A camera module for a vehicle or a driver according to a fifth embodiment of the invention may include or remove a driving member (not shown) around an optical system. That is, since the optical system is disposed in the vehicle, it is difficult to control the focus by moving the lens barrel supporting the optical system in an optical axis direction or/and a direction perpendicular to the optical axis direction with the driving member, so the driving member may be removed. The driving member may be an actuator or a piezoelectric element for an auto focus (AF) function or/and an optical image stabilizer (OIS) function. Here, the lens barrel supporting the optical system may include a metal material, for example, an aluminum material.

In the optical system according to the fifth embodiment of the invention, the angle of view (diagonal line) may be 70 degrees or less, for example, in the range of 55 degrees to 70 degrees. The effective focal length may be 8 mm or less, such as a range of 4 mm to 8 mm or a range of 5 mm to 6 mm. F number of the optical system or camera module may be 2.4 or less, for example, in the range of 1.8 to 2.4 or in the range of 2 to 2.3. The chief ray angle (CRA) may be greater than or equal to 20 degrees, e.g., in the range of 20 degrees to 35 degrees. In the optical system, a distance (TTL) between the image sensor 190 and the vertex of the first lens 151 may be 11 mm or less. In addition, the wavelength of light used in the optical system may be in the range of 870 nm to 1000 nm. When the temperature ranges from low temperature (e.g., −40 degrees) to high temperature (e.g., 85 degrees), the MTF reduction may be 10% or less. In the optical system according to the fifth embodiment of the invention, since the material of the lens barrel or the lens holder supporting the lenses is a metal material, for example, aluminum having high heat dissipation properties, the heat dissipation properties of the lenses may be improved. Accordingly, the proportion of lenses made of plastic in the optical system may be higher than that of lenses made of glass.

Table 9 shows lens data in the optical system of FIG. 50.

TABLE 9

| | | | | | | Abbe | | | |
|---|---|---|---|---|---|---|---|---|---|
| | | | Curvature | Thickness/ | Refractive | number | | Focal | Semi- |
| | Surface | Shape | radius | distance | Index | (Vd) | Diopter | length | aperture |
| Lens 1 | S1 | Asphere | −2.257 | 1.028 | 1.644 | 19.246 | −55.782 | −17.927 | 1.748 |
| | S2 | Asphere | −3.306 | 0.150 | | | | | 1.446 |
| Lens 2 | S3 | Asphere | 3.008 | 0.734 | 1.644 | 19.246 | 79.071 | 12.647 | 1.307 |
| | S4 | Asphere | 4.315 | 2.061 | | | | | 1.311 |
| Stop | | Flat | | | | | | | |
| Lens 3 | S5 | Sphere | 10.395 | 0.876 | 1.726 | 25.047 | 177.087 | 5.647 | 1.940 |
| | S6 | Sphere | −6.528 | 1.974 | | | | | 1.992 |
| Lens 4 | S7 | Asphere | 3.967 | 0.431 | 1.644 | 19.246 | −48.432 | −20.647 | 2.001 |
| | S8 | Asphere | 2.925 | 0.350 | | | | | 2.277 |
| BPF | Sa | Flat | 1.E+18 | 0.400 | 1.508 | 64.166 | | | |
| | Sb | Flat | 1.E+18 | 1.000 | | | | | |
| | Sc | Flat | 1.E+18 | 0.400 | 1.508 | 64.166 | | | |
| Cover glass | Sd | Flat | 1.E+18 | 0.200 | | | | | |
| CIS | | Flat | 1.E+18 | 0.000 | | | | | |

In Table 9, the refractive indices (Index) of the first to fourth lenses 151, 152, 153, and 154 are the refractive indices at 587 nm, and the Abbe numbers Vd of the first to fourth lenses 151, 152, 153, and 154 at d-line (587 nm) may be less than 30. Based on Table 9 above, values of radius, thickness, distance, refractive index, Abbe number, and focal length may also be expressed by the above relational expression. For example, looking at the focal length expressed as an absolute value, the relational expression may be in the order of fourth lens>first lens>second lens>third lens.

Table 10 is the aspherical coefficient of each surface of each lens in the optical system of FIG. 50.

TABLE 10

| | | Aspherical coefficient | | | | | | | | | |
|---|---|---|---|---|---|---|---|---|---|---|---|
| Item | Surface | K | A | B | C | D | E | F | G | H | J |

| | | | | |
|---|---|---|---|---|
| Lens 1 | S1 | −5.97034 | 0.01341 | −0.00050 |
| | S2 | −6.42082 | 0.02032 | −0.00041 |
| Lens 2 | S3 | −8.72772 | −0.00817 | −0.00505 |
| | S4 | −25.08775 | −0.02416 | −0.00144 |
| Lens 3 | S5 | | | |
| | S6 | | | |
| Lens 4 | S7 | −8.08261 | −0.03718 | −0.00260 |
| | S8 | −0.31062 | −0.05483 | 0.00189 |

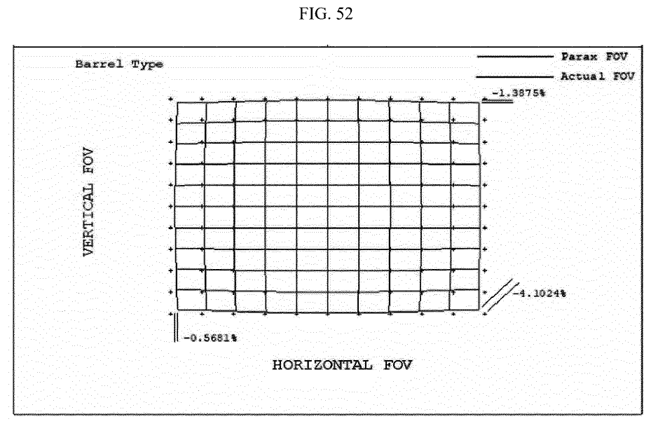

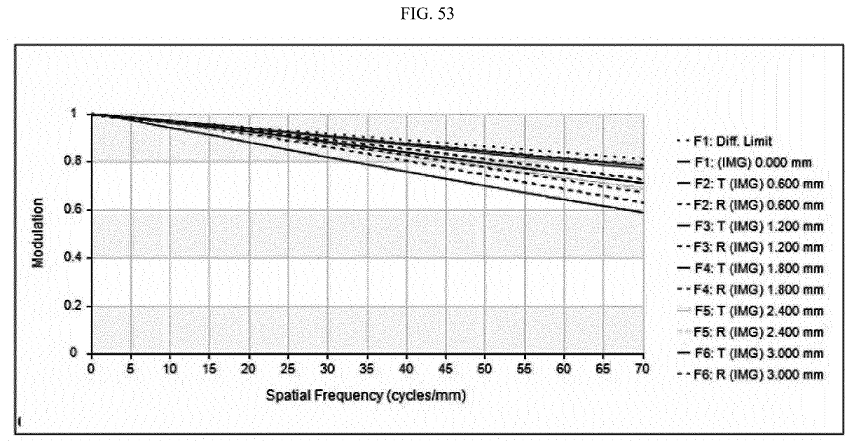

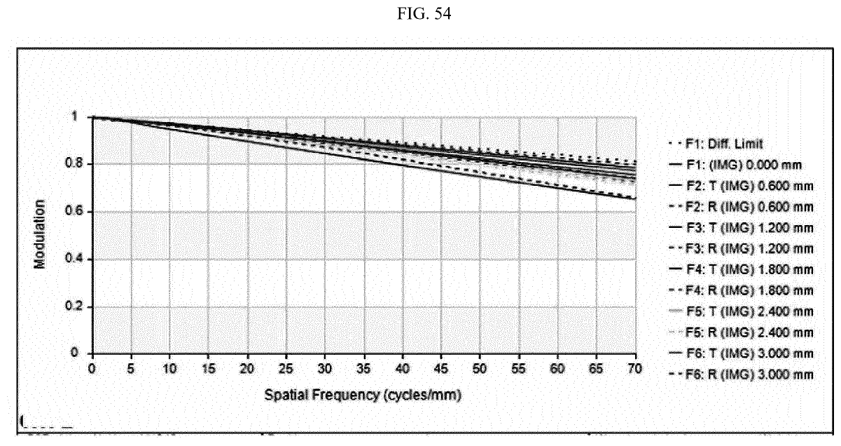

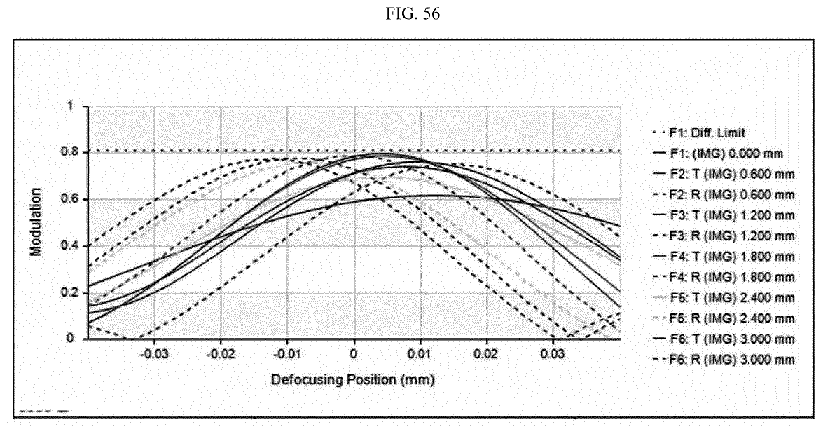

FIG. 51 is a graph showing the ambient light ratio or relative illumination according to the image height in the optical system of FIG. 50, and it may be seen that relative illumination ratio of 55% or more, for example, 70% or more, appears from the center of the image sensor to the diagonal end. FIG. 52 is a diagram showing actual FOV and parax FOV for horizontal FOV (Field of View) and vertical FOV at room temperature (e.g., 22 degrees) in the optical system of FIG. 50. FIGS. 53 to 55 are graphs showing the diffraction MTF at low temperature, room temperature, and high temperature in the optical system of FIG. 50, and are graphs showing the luminance ratio (modulation) according to the spatial frequency, and FIGS. 56 to 58 are graphs showing the diffraction MTF at low temperature, room temperature, and high temperature in the optical system of FIG. 50, and are graphs showing the luminance ratio according to the defocusing position. As shown in FIGS. 53 to 58, it may be seen that the lowering of the luminance modulation is less than 10% and almost unchanged at a low temperature of −40 degrees, a room temperature of 22 degrees, and a high temperature of 85 degrees. As shown in FIGS. 59 to 61, it may be seen that in the optical system of FIG. 50, astigmatic field curves and distortion at low temperature, room temperature, and high temperature are +11 or less (1.0 filed). As shown in FIGS. 53 to 61, it may be seen that the change in data according to the temperature change from low temperature to high temperature is not large, less than 10%.

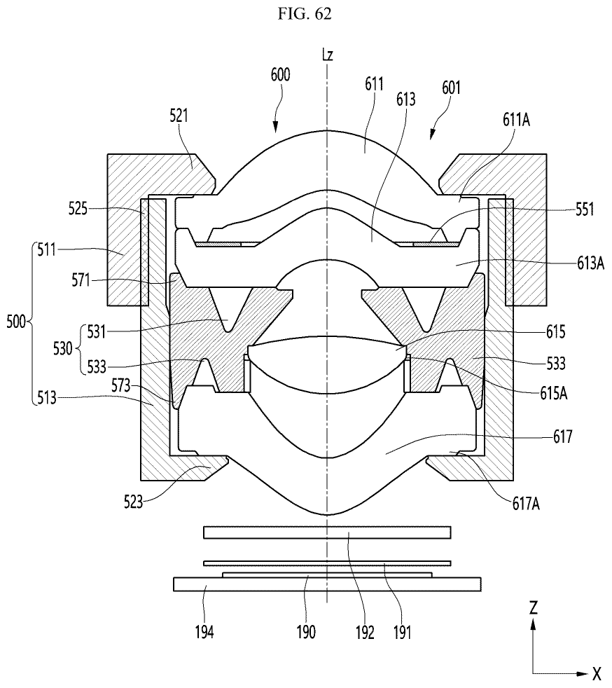

FIG. 62 is a side cross-sectional view showing an example of a camera module having an optical system according to an embodiment of the invention. Referring to FIG. 62, a camera module according to an embodiment of the invention may include a housing 500, a lens portion 600 having a plurality of lenses 611, 613, 615, and 617 or an optical system, spacers 551 and 133, a main substrate 194, and an image sensor 190. The camera module may include a cover glass 194 and an optical filter 192 between the lens portion 600 and the image sensor 190. The lens portion 600 may include the optical system disclosed in the embodiment(s), and may include, for example, an optical system in which at least three or more lenses 611, 613, 615, and 617 are stacked, for example, three to seven lenses or three to five lenses. An optical system in which five lenses are stacked may be included. The lens portion 600 may include at least three or more solid lenses, and the solid lens may include at least one plastic lens. In the lens portion 600 according to an embodiment of the invention, one or more lenses made of plastic may be included. For convenience of description, the lens portion 600 includes a first lens 611, a second lens 613, a third lens 615, and a fourth lens 617 stacked along the optical axis Lz toward the image sensor 190 from the object side.

The first lens 611 is a lens closest to the subject, and at least one or both of an upper surface through which light is incident and a lower surface through which light exits may be spherical or aspherical surface. An upper or lower surface of the first lens 611 may be concave or convex. The first lens 611 may be made of plastic to inhibit discoloration when the camera module is exposed to light from inside or outside the vehicle, and may be made of glass or plastic when the camera module is placed inside the vehicle. The second lens 613 may be made of glass or plastic. The second lens 613 is disposed between the first lens 611 and the third lens 615, and may have a flange portion 613A at the outside thereof. The third lens 615 may be made of glass or plastic. The fourth lens 617 is a lens closest to the image sensor 190 and may be made of glass or plastic. The upper and/or lower surfaces of the second lens 613, the third lens 615, and the fourth lens 617 may be spherical or aspherical surface, but are not limited thereto.

The lenses 611, 613, 615, and 617 of the lens portion 600 may be coupled in the lens holder 513 of the housing 500 from the upper portion to the sensor side, coupled in the opposite direction, or coupled in both directions. A gasket 525 may be included between the cover 511 and the lens holder 513, and the gasket 525 may be a waterproof ring.

The housing 500 includes a cover 511 and a lens holder 513, and may have an opening 601 penetrating from an upper portion to a lower portion. The cover 511 and the lens holder 513 may be integrally formed, or may be separated or combined with each other. The cover 511 may be a cover coupled to the outer circumference of the lens holder 513 from the upper portion, and the inner protrusion 521 of the cover 511 may support the circumference of the first lens 611, The inner protrusion 523 of the lens holder 513 may be disposed below the flange portion 617A of the fourth lens 617. Each of the lenses 611, 613, 615, and 617 may include an effective region having an effective diameter through which light is incident, and flange portions 611A, 613A, 615A, and 617A, which are non-effective regions, outside the effective region. The ineffective region may be a region in which light is blocked by the spacers 551 and 553. The flange portions 611A, 613A, 615A, and 617A may extend in a circumferential direction with respect to the optical axis Lz in effective regions of the lenses 611, 613, 615, and 617. At least one 615 of the lenses 611, 613, 615, and 617 may not have a flange portion or may have a shorter length than other lenses.

The lens holder 513 protects and supports the outer surface of the lens portion 600. The lens holder 513 supports outer surfaces of the plurality of lenses 611, 613, 615, and 617. The lens holder 513 may be a lens barrel, and may be provided with one or a plurality of barrels. The top view shape of the housing 500 may include a circular column shape or a polygonal column shape. The housing 500 may be formed of a material such as resin, plastic, or metal. A hydrophilic material may be coated or coated on the surface of the housing 500. Here, the lens holder 513 may be formed of a metal material, for example, it may be selected from Al, Ag, or Cu material, preferably, Al or an Al alloy. When the lens holder 513 is made of metal, heat transmitted in the lateral direction of the lenses 611, 613, 615, and 617 may be dissipated, and thermal deformation of the lenses 611, 613, 615, and 617 may be suppressed.

The image sensor 190 may be disposed on the main substrate 194. The image sensor 190 may be mounted, seated, contacted, fixed, temporarily fixed, supported, or coupled to the main substrate 194 on a plane crossing the optical axis Lz. Alternatively, according to another embodiment, a groove or hole (not shown) capable of accommodating the image sensor 190 may be formed in the main substrate 194, and the embodiment is not limited to a specific form in which the image sensor 190 is disposed on the main board 180. The main substrate 194 may be a rigid PCB or FPCB.

The image sensor 190 may perform a function of converting light passing through the lens portion 600 into image data. A sensor holder may be disposed under the housing 500 to surround the image sensor 190 and protect the image sensor 190 from external foreign substances or shocks. The image sensor 190 may be any one of a charge coupled device (CCD), complementary metal-oxide semiconductor (CMOS), CPD, and CID. When the number of image sensors 190 is plural, one may be a color (RGB) sensor and the other may be a black and white sensor.

The optical filter 192 may be disposed between the lens portion 600 and the image sensor 190. The optical filter 192 may filter light corresponding to a specific wavelength range from light passing through the lenses 611, 613, 615, and 617. The optical filter 192 may be an infrared (IR) blocking filter that blocks infrared rays or an ultraviolet (UV) blocking filter that blocks ultraviolet rays, but the embodiment is not limited thereto. The optical filter 192 may be disposed on the image sensor 190. The cover glass 191 is disposed between the optical filter 192 and the image sensor 190, protects an upper portion of the image sensor 190, and may inhibit deterioration in reliability of the image sensor 190.

The camera module according to an embodiment of the invention may include a driving member (not shown), wherein the driving member may be moved or tilted to the barrel having at least one of the lenses in an optical axis direction or/and a direction orthogonal to the optical axis direction. The camera module may include an auto focus (AF) function and/or an optical image stabilizer (OIS) function. Here, the lens portion 600 may be stacked with plastic lenses or glass lenses, or mixed with each other. Here, the plastic material may be 5 times higher than the coefficient of thermal expansion (CTE) of the glass material, and the change value (dN/dT) of the refractive index as a function of temperature may be 10 times lower than the glass material. Here, dN is the change value of the refractive index of the lens, and dT represents the change value of the temperature.

In the case of using a plastic lens for a camera module in a vehicle, the price may be lowered compared to a lens made of glass, and light path control may be facilitated by providing aspherical surfaces on an incident side and an exit side. In addition, a lens made of glass or plastic may expand or contract due to a difference in thermal expansion coefficient from that of the lens holder 513. Due to this, the lens may be deformed in the optical axis direction when the expansion is not relieved in the longitudinal direction, and a problem in that the optical characteristics of the lens may be changed may occur. Therefore, when there is no buffer structure outside the effective region of the lens to alleviate the expansion of the lens, the heights of the incident-side surface and the exit-side surface of the lens may be different, which may affect the optical properties of the lens. That is, when a spacer without a buffer structure is disposed outside the lens, expansion of the lens in the longitudinal direction cannot be alleviated, and the lens is deformed in the direction of the optical axis Lz.

In an embodiment of the invention, a member or means having a buffer structure is disposed between at least one effective diameter region among the plurality of lenses 611, 613, 615, and 617 and the lens holder 513, so that a change in optical characteristics of the effective diameter region may be suppressed. A member or means may be a flange portion disposed outside the effective diameter region of the lens or/and a spacer disposed between the lens and the lens holder. An embodiment of the invention will be described as an example in which the buffer structure 530 is provided to at least one of the spacers 551 and 133. The spacer 553 having the buffer structure 530 may suppress a change in optical characteristics of the third lens 615 disposed therein. The spacers 551 and 553 may block light leaked or introduced to the outside, and a distance between two adjacent lenses may be adjusted. The spacers 551 and 553 may be defined as light blocking films (Spacer film). Here, the spacer 133 having the buffer structure 530 may function as an aperture stop. A surface of the spacer 133 having the buffer structure 530 may be coated with a light blocking material to block light. Here, a gap may be included between at least one of the plurality of lenses 611, 613, 615, and 617 and the lens holder 513. For example, the spacers 551 and 133 may have openings therein. The spacers 551 and 553 may include a first spacer 551 disposed around the outer circumference of the first lens 611 and the second lens 613, and a second spacer 553 disposed around the second lens 131 and the fourth lens 617. The second spacer 553 may support the flange portion 61A of the third lens 615 at an inner circumference.

The second spacer 553 having the buffer structure 530 is disposed between the second lens 613 and the fourth lens 617 and spaced apart between the third lens 613 and the fourth lens 617 to support the outside of the third lens 615. A region between the outer side of the third lens 615 and the second spacer 553 may be bonded with an adhesive. Here, the second spacer 553 with the buffer structure 530 is shown as an example of being placed outside the third lens 133, but may be placed outside the first lens 611, the second lens 613, or/and the fourth lens 617. The buffer structure 530 may include a structure having grooves 531 and 553 in upper and lower portions. The grooves 531 and 553 may be formed in a continuous ring shape.

The buffer structure 530 may include a first groove 531 concave from the object-side surface toward the image sensor side and a second groove 533 concave from the sensor side toward the object-side surface. The first groove 531 and the second groove 533 may be alternately arranged on different planes based on the optical axis Lz. The buffer structure 530 having the first groove 531 and the second groove 533 may inhibit the rigidity of the second spacer 553 from deteriorating and shrink or expand according to thermal deformation of the third lens 615. When viewed from a top view, the first groove 531 may have a continuous circular shape or a ring shape. A plurality of first grooves 531 may be formed in a circular or ring shape, and the plurality of first grooves 531 may be arranged in concentric circles having different radii. The plurality of first grooves 531 may overlap in a direction orthogonal to the optical axis Lz. A plurality of second grooves 533 may be formed in a circular or ring shape, and the plurality of second grooves 533 may be arranged in concentric circles having different radii. The plurality of second grooves 533 may overlap in a direction orthogonal to the optical axis Lz.

Side cross sections of the first groove 531 and/or the second groove 533 may have a triangular shape. The triangular shape may be a shape in which two points contacting the upper or lower surface and the deepest point are connected. The portion where the deepest point is disposed may be an angular surface, a curved surface, or a flat surface. The first groove 531 may have a triangular shape with a wide top and a narrow bottom, and the second groove 533 may have a triangular shape with a wide bottom and a narrow top, that is, an inverted triangle shape. The embodiment of this invention provides a buffer structure 530 with at least two grooves 531,533, in the outer spacer 553 of the third lens 615, which may be elastic and alleviated against thermal expansion of the third lens 615, and may suppress changes in the Z-axis (optical axis) direction of the third lens 615.

The second spacer 553 having the buffer structure 530 may be formed of a material having a higher thermal expansion coefficient than a glass material or a material having a higher thermal expansion coefficient than a metal material. The spacer 553 having the buffer structure 530 may be formed of a plastic material, for example, a thermoplastic or thermosetting material.

The first spacer 551 and the second spacer 553 may be made of the same material or different materials, for example, they may be made of a material that absorbs light. The first and/or second spacers 551 and 553 may include a poly ethylene film (PE) film or a polyester (PET) film. As another example, the first or/and second spacers 551 and 553 may have a metal or alloy and an oxide film formed on their surfaces. Materials included in the group metal or alloy may include at least one of In, Ga, Zn, Sn, Al, Ca, Sr, Ba, W, U, Ni, Cu, Hg, Pb, Bi, Si, Ta, H, Fe, Co, Cr, Mn, Be, B, Mg, Nb, Mo, Cd, Sn, Zr, Sc, Ti, V, Eu, Gd, Er, Lu, Yb, Ru, Y, and La. The oxide film may be an oxide material treated with black oxide or brown oxide using copper.

The third lens 615 disposed inside the second spacer 553 having the buffer structure 530 may be made of glass or plastic. A thickness of the second spacer 553 may be greater than a height of an outer surface of the third lens 615. A thickness of the second spacer 553 may be greater than a thickness of a central portion of the third lens 615. An upper surface of the second spacer 553 may contact the second lens 613. A lower surface of the second spacer 553 may contact the fourth lens 617. The second spacer 553 may include a first portion 571 disposed between the flange portion 613A of the second lens 613 and the lens holder 513, and a second portion 573 disposed between a flange portion 617A of the fourth lens 617 and the lens holder 513. The second spacer 553 may protect the outside of the third lens 615 and the outside of the second lens 613 and the fourth lens 617.

Hereinafter, an example of a buffer structure 530 in the outer second spacer 553 of the third lens 615 may be described, and the buffer structure 530 may buffer the length of the third lens 615 when the length of the third lens 615 expands depending on the ambient temperature. The buffer structure 530 may provide elasticity in a direction orthogonal to the optical axis Lz or in a circumferential direction in the second spacer 553. The flange region of the second lens 613 is supported by the second spacer 553, and the center of the outermost surface of the flange region may not overlap each of the grooves 531 and 533 in a first direction perpendicular to the optical axis Lz. At least one of the sensor side or the lower edge of the outermost surface of the second lens 613 may be on the same line as the lowest point of each groove 531 or 533.

Therefore, since the buffer structure 530 is provided in the second spacer 553, the second lens 613 may provide elasticity against expansion or contraction in the lateral direction. Accordingly, the expansion transmitted to the second spacer 553 may be alleviated to suppress the effective diameter region of the third lens 615 from being deformed in the optical axis direction, which may minimize the change in the optical characteristics (MTF: Modulation Transfer Function) of the lens 613.

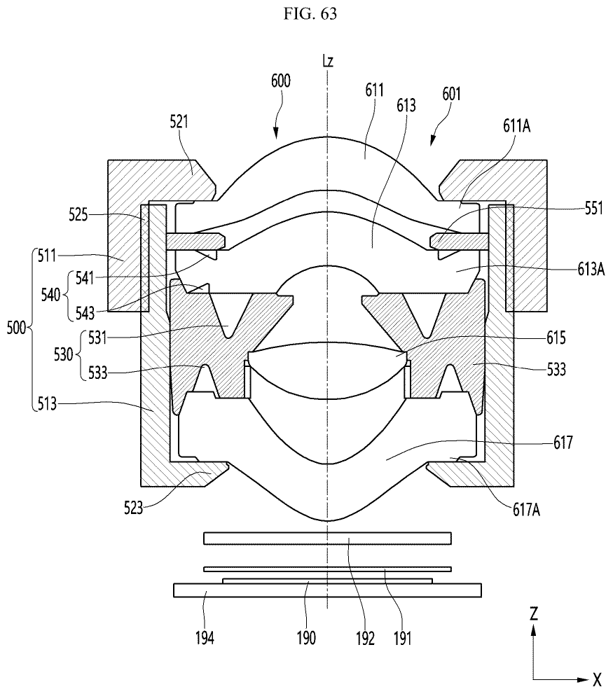

Referring to FIG. 63, the camera module may define the buffer structure 530 of the second spacer 553 as a first buffer structure and the buffer structure 540 of the lens as a second buffer structure. A lens having the second buffer structure 540 may be disposed on at least one or two or more of the first to fourth lenses. The second buffer structure 540 may be formed as a concave groove on the upper and lower surfaces of the flange portion of the lens. The first buffer structure 530 of the spacer 553 will be referred to the description of the embodiment disclosed above, and the second buffer structure 540 of the second lens 613 will be described below. The second lens 613 having the second buffer structure 540 may be disposed between the first lens 611 and the third lens 615. The second buffer structure 540 may contact the first spacer 551. The second buffer structure 540 may contact the second spacer 553.

The concave groove 541 at the upper surface of the second buffer structure 540 may face the upper surface of the first spacer 551. The concave groove 543 on the lower surface of the second buffer structure 540 may face the upper surface of the second spacer 553. The upper and lower grooves 541 and 543 of the second buffer structure 540 may overlap the effective diameter area in the first direction X orthogonal to the optical axis Lz. The upper and lower grooves 541 and 543 of the second buffer structure 540 may overlap an outer side surface of the second lens 613 in a first direction X orthogonal to the optical axis Lz. The second lens 613 to which the second buffer structure 540 is applied may be made of a plastic material. The second buffer structure 540 applied to the second lens 613 made of plastic according to an embodiment of the invention may buffer when the volume of the second lens 613 expands according to the ambient temperature. The second buffer structure 540 may be provided on the flange portion 613A of the second lens 613, and may be provided as a structure that provides elasticity in a direction orthogonal to the optical axis Lz or in a circumferential direction.

Features, structures, effects, etc. described in the embodiments above are included in at least one embodiment of the invention, and are not necessarily limited to only one embodiment. Furthermore, the features, structures, and effects illustrated in each embodiment can be combined or modified with respect to other embodiments by those skilled in the art in the field to which the embodiments belong. Therefore, contents related to these combinations and variations should be construed as being included in the scope of the invention. In addition, although the above has been described with a focus on the embodiments, these are only examples and do not limit the invention, and those skilled in the art to which the invention belongs can exemplify the above to the extent that does not deviate from the essential characteristics of the present embodiment. It will be seen that various variations and applications that have not been made are possible. For example, each component specifically shown in the embodiment can be modified and implemented. And differences related to these modifications and applications should be construed as being included in the scope of the invention as defined in the appended claims.

1. An optical system comprising:
a first lens, a second lens, a third lens, and a fourth lens disposed along an optical axis from an object side toward a sensor side,
wherein the first lens includes an object-side first surface and a sensor-side second surface on the optical axis,
wherein the second lens includes an object-side third surface and a sensor-side fourth surface,
wherein the third lens includes an object-side fifth surface and a sensor-side sixth surface,
wherein the fourth lens includes an object-side seventh surface and a sensor-side eighth surface,
wherein the first lens has a negative refractive power,
wherein the third lens has a positive refractive power,
wherein the fourth lens has a negative refractive power,
wherein the first lens and the fourth lens include a plastic material,
wherein the third lens includes a glass material, and
wherein a distance between the third and fourth lenses is a largest among distances between two adjacent lenses.

2. An optical system comprising:
a first lens, a second lens, a third lens, and a fourth lens disposed along an optical axis from an object side toward a sensor side,
wherein the first lens includes an object-side first surface and a sensor-side second surface on the optical axis,
wherein the second lens includes an object-side third surface and a sensor-side fourth surface,
wherein the third lens includes an object-side fifth surface and a sensor-side sixth surface,
wherein the fourth lens includes an object-side seventh surface and a sensor-side eighth surface,
wherein the first lens has a negative refractive power,
wherein the third lens has a positive refractive power,
wherein the fourth lens has a negative refractive power,
wherein the first to fourth lenses have a ratio of a plastic material to a glass material of 3:1, and
wherein a distance between the third and fourth lenses is a largest among distances between two adjacent lenses.

3. The optical system of claim 1, wherein the second lens is made of a plastic material, and
wherein the second lens has a positive refractive power.

4. The optical system of claim 1, wherein a ratio of a spherical surface to an aspherical surface on the optical axis among the first to eighth surfaces of the first to fourth lenses is 1:3.

5. The optical system of claim 1, wherein a distance on the optical axis from a center of the object-side first surface of the first lens to a surface of the image sensor is TTL, and
wherein the TTL is 11 mm or less, and F number is 2 to 2.3.

6. The optical system of claim 1, wherein the first lens has the first surface concave and the second surface concave on the optical axis,
wherein the second lens has the third surface convex and the fourth surface convex on the optical axis,
wherein the third lens has the fifth surface convex and the sixth surface convex on the optical axis,
wherein the fourth lens has the seventh surface convex and the eighth surface concave on the optical axis, and
wherein the distance between the third and fourth lenses is a distance on the optical axis.

7. The optical system of claim 6
wherein a center thickness of the second lens has a larger thickness than center thicknesses of each of the first and third lenses.

8. The optical system of claim 1, wherein the first lens has the first surface convex and the second surface concave on the optical axis,
wherein the second lens has the third surface concave and the fourth surface convex on the optical axis,
wherein the third lens has the fifth surface convex and the sixth surface concave on the optical axis,
wherein the fourth lens has the seventh surface convex and the eighth surface concave on the optical axis,
wherein a center thickness of the second lens is a thickest among center thickness of the first to fourth lenses, and
wherein the distance between the third and fourth lenses is a distance on the optical axis.

9. The optical system of claim 1, wherein the first lens has the first surface concave and the second surface convex on the optical axis,
wherein the second lens has the third surface convex and the fourth surface concave on the optical axis,
wherein the third lens has the fifth surface convex and the sixth surface convex on the optical axis,
wherein the fourth lens has the seventh surface convex and the eighth surface concave on the optical axis,
wherein a center thickness of the first lens is a thickest in the optical system, and
wherein a distance between the second and third lenses and a distance between the third and fourth lenses on the optical axis is 1 mm or more.

10. The optical system of claim 1, comprising an aperture stop disposed around a circumference between the second lens and the third lens.

11. A camera module comprising:
an image sensor;
an optical filter on the image sensor;
a cover glass disposed between the optical filter and the image sensor;
an optical system including a first lens, a second lens, a third lens, and a fourth lens disposed along an optical axis from an object side toward a sensor side; and
an aperture stop disposed around a circumference between the second lens and the third lens,
wherein an effective diameter of the first lens is larger than an effective diameter of each of the second and third lenses,
wherein the third lens includes a glass material,
wherein object-side surfaces and sensor-side surfaces of each of the first, second, and fourth lenses are aspherical surface,
wherein the first lens has a negative refractive power,
wherein the second and third lenses have a positive refractive power,
wherein the fourth lens has a negative refractive power, and
wherein a distance between the third and fourth lenses is a largest among distances between any two adjacent lenses in the optical system.

12. The camera module of claim 11, wherein a lens barrel having the first to fourth lenses is made of a metal.

13. The optical system of claim 2, wherein the second lens is made of a plastic material, and
wherein the second lens has a positive refractive power.

14. The optical system of claim 2, wherein a ratio of a spherical surface to an aspherical surface on an optical axis among the first to eighth surfaces of the first to fourth lenses is 1:3.

15. The optical system of claim 2, wherein a distance on the optical axis from a center of the object-side first surface of the first lens to a surface of the image sensor is TTL, and
wherein the TTL is 11 mm or less, and F number is 2 to 2.3.

16. The optical system of claim 2, wherein the first lens has the first surface concave and the second surface concave on the optical axis,
wherein the second lens has the third surface convex and the fourth surface convex on the optical axis,
wherein the third lens has the fifth surface convex and the sixth surface convex on the optical axis,
wherein the fourth lens has the seventh surface convex and the eighth surface concave on the optical axis, and
wherein the distance between the third and fourth lenses is a distance on the optical axis.

17. The optical system of claim 16,
wherein a center thickness of the second lens has a larger thickness than a center thicknesses of the first and third lenses.

18. The optical system of claim 2, wherein the first lens has the first surface convex and the second surface concave on the optical axis,
wherein the second lens has the third surface concave and the fourth surface convex on the optical axis,
wherein the third lens has the fifth surface convex and the sixth surface concave on the optical axis,
wherein the fourth lens has the seventh surface convex and the eighth surface concave on the optical axis,
wherein a center thickness of the second lens is a thickest among center thickness of the first to fourth lenses, and
wherein the distance between the third and fourth lenses is a distance on the optical axis.

19. The optical system of claim 2, wherein the first lens has the first surface concave and the second surface convex on the optical axis,
wherein the second lens has the third surface convex and the fourth surface concave on the optical axis,
wherein the third lens has the fifth surface convex and the sixth surface convex on the optical axis,
wherein the fourth lens has the seventh surface convex and the eighth surface concave on the optical axis,
wherein a center thickness of the first lens is a thickest in the optical system, and
wherein a distance between the second and third lenses and a distance between the third and fourth lenses on the optical axis is 1 mm or more.

20. The optical system of claim 2, comprising an aperture stop disposed around a circumference between the second lens and the third lens.
